(19) United States
(12) Patent Application Publication
(10) Pub. No.: US 2025/0133035 A1
(43) Pub. Date: Apr. 24, 2025

(54) PUBLISH-SUBSCRIBE CLASSIFICATION IN A CROSS-DOMAIN SOLUTION

(71) Applicants: Stanley T. Mo, Portland, OR (US); Akhilesh Thyagaturu, Ruskin, FL (US); Nicholas G. Ross, Lake Forest, CA (US); Jason Howard, Portland, OR (US); Sanjaya Tayal, Portland, OR (US)

(72) Inventors: Stanley T. Mo, Portland, OR (US); Akhilesh Thyagaturu, Ruskin, FL (US); Nicholas G. Ross, Lake Forest, CA (US); Jason Howard, Portland, OR (US); Sanjaya Tayal, Portland, OR (US)

(21) Appl. No.: 19/003,090

(22) Filed: Dec. 27, 2024

(51) Int. Cl. H04L 49/9047; H04L 67/55

(52) U.S. Cl. CPC H04L 49/9047; H04L 67/55

(57) ABSTRACT

A cross-domain device includes interfaces to couple to a first device, second device, and third device. The cross-domain device creates a first buffer in its shared memory to allow writes by the first device associated with a first software module and reads by the second device associated with a second software module, and creates a second buffer in the shared memory separate from the first buffer to allow writes by the first device associated with the first software module and reads by the third device associated with a third software module. The cross-domain device uses the first buffer to implement a first memory-based communication link between the first software module and the second software module, and uses the second buffer to implement a second memory-based communication link between the first software module and the third software module.

### BACKGROUND

A data center may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE FIGURES

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a simplified block diagram illustrating example components of a data center.

FIG. 2 is a simplified block diagram illustrating an example computing system.

FIG. 3 is an example approach for networking and services in an edge computing system.

FIG. 4 is a simplified block diagram illustrating an example computing device.

FIG. 5 is a simplified block diagram illustrating an example computing system.

FIG. 6 is a simplified block diagram illustrating an example cross-domain solution (CDS).

FIG. 7 is a simplified block diagram illustrating an example memory-based CDS (M-CDS) implementation.

FIG. 8 is a simplified block diagram illustrating example deployment of M-CDS devices to couple different computing domains.

FIG. 9 is a simplified block diagram illustrating an example M-CDS device.

FIG. 10 is a simplified block diagram illustrating example M-CDS management logic.

FIG. 11 is a simplified block diagram illustrating example components of an example M-CDS device.

FIG. 12 is a simplified block diagram illustrating the coupling of clients in two computing domains through an example M-CDS device.

FIG. 13 is a simplified flow diagram illustrating the example creation and use of memory-based communication channels using an example M-CDS device.

FIG. 14 is a simplified block diagram illustrating an example system including multiple different domains.

FIG. 15 is a simplified block diagram illustrating an example system including an M-CDS device and publisher and subscriber systems.

FIG. 16 is a simplified block diagram illustrating an example classification of image data in a publisher-subscriber system including a CDS device.

FIG. 17 is a simplified block diagram illustrating an example CDS publish-subscribe architecture.

FIG. 18 is a simplified flow diagram illustrating an example transaction flow.

FIG. 19 is a simplified block diagram illustrating an example publisher system.

FIG. 20 is a simplified block diagram illustrating an example splitting of an example RAN processing platform.

FIG. 21 is a simplified block diagram illustrating example use of a CDS device in an Open RAN environment.

FIG. 22 illustrates a block diagram of an example processor device in accordance with certain embodiments.

Like reference numbers and designations in the various drawings indicate like elements.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

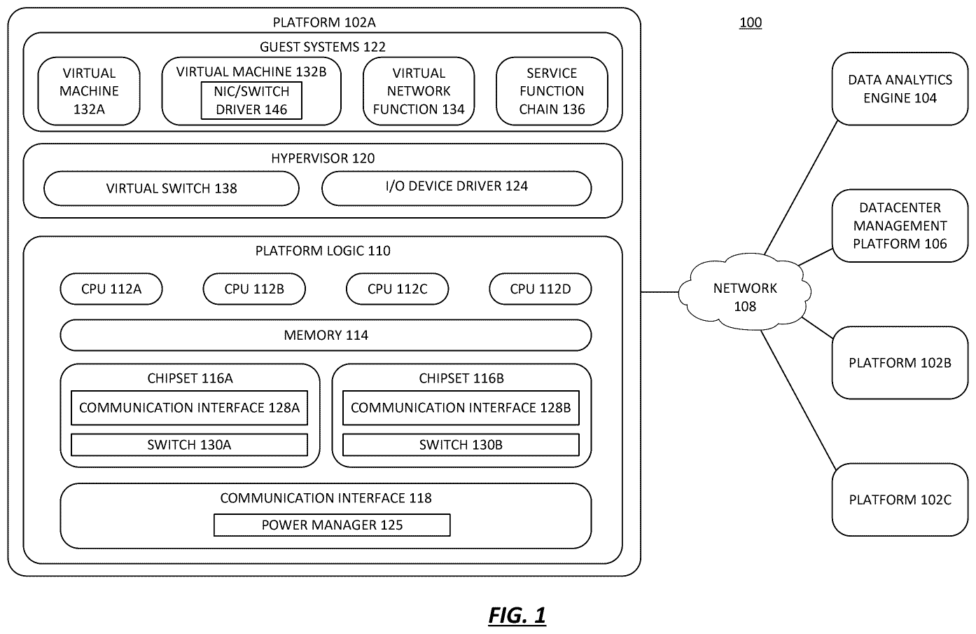

FIG. 1 illustrates a block diagram of components of a datacenter 100 in accordance with certain embodiments. In the embodiment depicted, datacenter 100 includes a plurality of platforms (e.g., 102B-102C), data analytics engine 104, and datacenter management platform 106 coupled together through network 108. In some implementations, the connection between a platform (e.g., 102) and other platforms, engines, and devices may be facilitated through a memory-based communication channel, such as implemented through a memory-based cross-domain solution (M-CDS) device, such as discussed herein. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, Ultra Path Interconnect (UPI), Universal Chiplet Interconnect Express (UCIe), and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

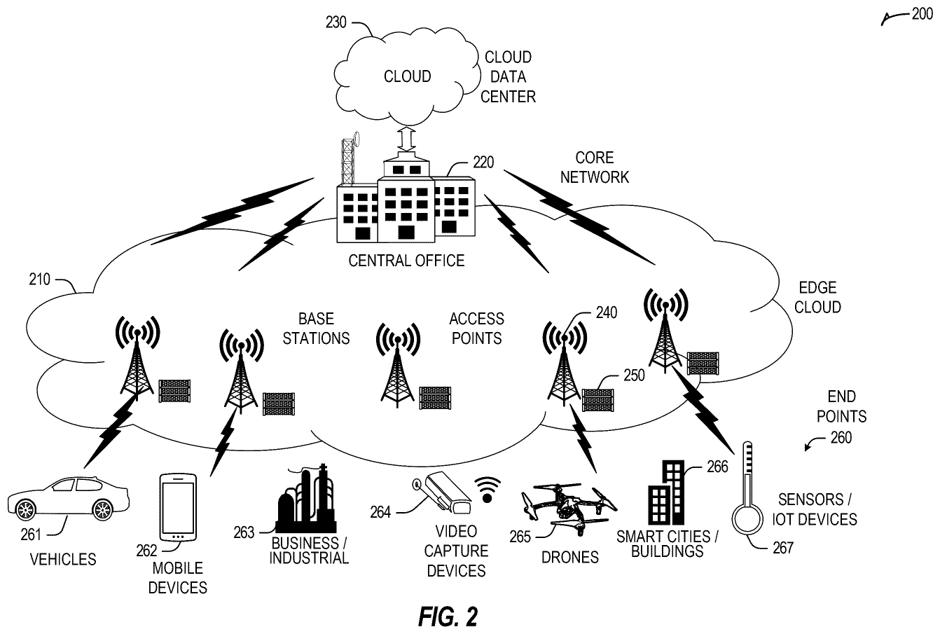

A data center, such as introduced above, may be utilized in connection with a cloud, edge, machine-to-machine, or loT system. Indeed, principles of the solutions discussed herein may be employed in datacenter systems (e.g., server platforms) and/or devices utilized to implement a cloud, edge, or loT environment, among other example computing environments. For instance, FIG. 2 is a block diagram 200 showing an overview of a configuration for edge computing, which includes a layer of processing referred to in many of the following examples as an “edge cloud” or “edge system”. As shown, the edge cloud 210 is co-located at an edge location, such as an access point or base station 240, a local processing hub 250, or a central office 220, and thus may include multiple entities, devices, and equipment instances. The edge cloud 210 is located much closer to the endpoint (consumer and producer) data sources 260 (e.g., autonomous vehicles 261, user equipment 262, business and industrial equipment 263, video capture devices 264, drones 265, smart cities and building devices 266, sensors and loT devices 267, etc.) than the cloud data center 230. Compute, memory, and storage resources which are offered at the edges in the edge cloud 210 may be leveraged to provide ultra-low latency response times for services and functions used by the endpoint data sources 260 as well as reduce network backhaul traffic from the edge cloud 210 toward cloud data center 230 thus improving energy consumption and overall network usages among other benefits.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 210.

As such, an edge cloud 210 may be formed from network components and functional features operated by and within edge gateway nodes, edge aggregation nodes, or other edge compute nodes among network layers. An edge cloud 210 may be embodied as any type of network that provides edge computing and/or storage resources which are proximately located to radio access network (RAN) capable endpoint devices (e.g., mobile computing devices, loT devices, smart devices, etc.), which are discussed herein. In other words, the edge cloud 210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks. Further, connections between nodes and services may be implemented, in some cases, using M-CDS devices, such as discussed herein.

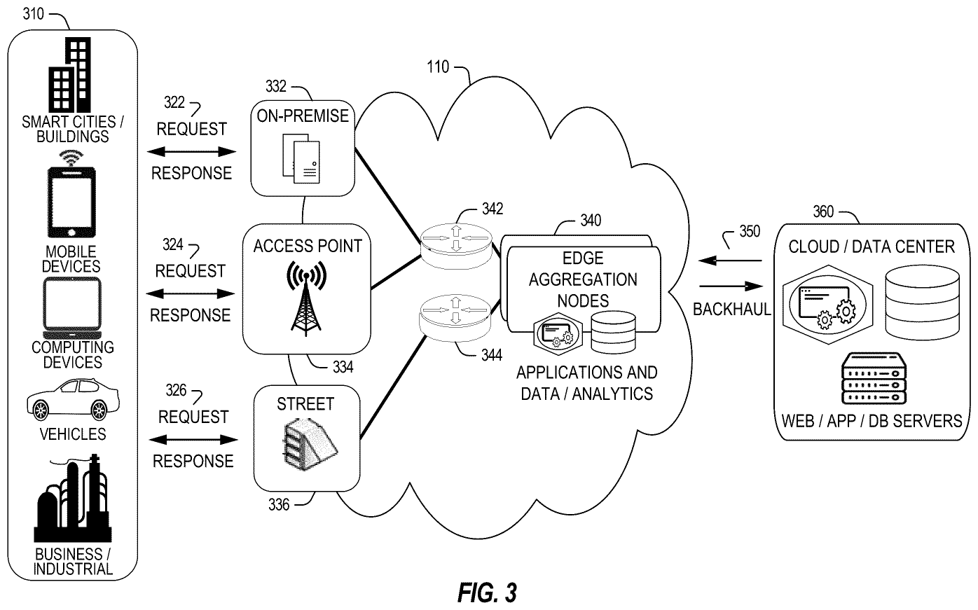

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 210 to aggregate traffic and requests. Thus, within the edge cloud 210, the TSP may deploy various compute and storage resources, such as at edge aggregation nodes 340, to provide requested content. The edge aggregation nodes 340 and other systems of the edge cloud 210 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 210 or other areas of the TSP infrastructure.

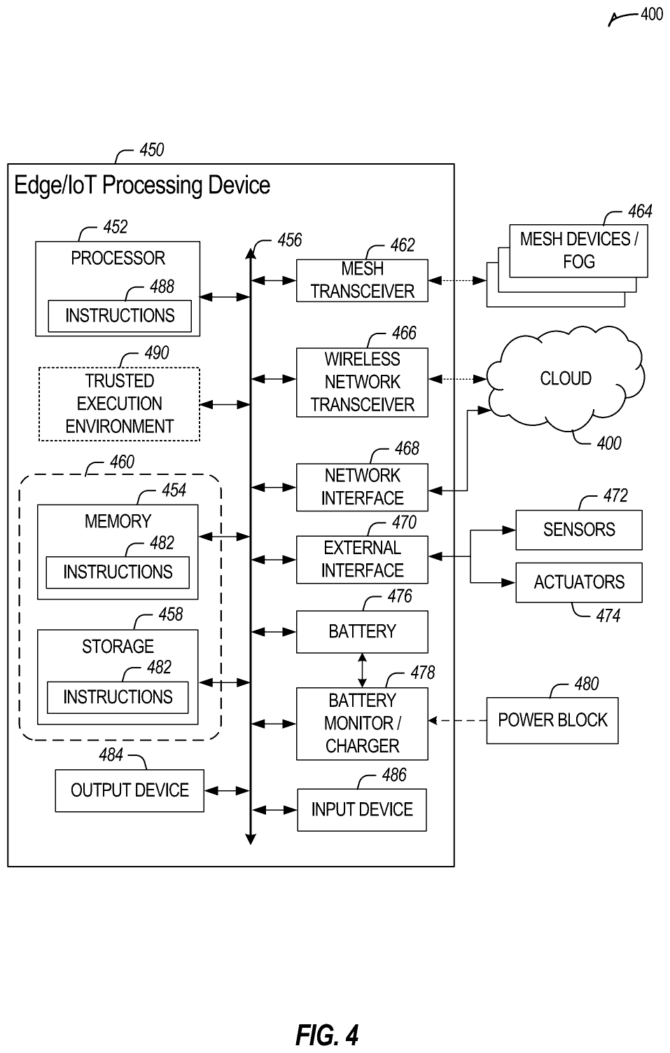

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangements of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, XD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including PCI express (PCIe), Compute Express Link (CXL), NVLink, HyperTransport, or any number of other technologies. The interconnect 456 may be a proprietary bus, for example, used in a SoC based system. Other bus systems may be included, such as an 12C interface, an SPI interface, point to point interfaces, and a power bus, among others. In some implementations, the communication may be facilitated through an M-CDS device, such as discussed herein. Indeed, in some implementations, communications according to a conventional interconnect protocol (e.g., PCIe, CXL, Ethernet, etc.) may be emulated via messages exchanged over the M-CDS, among other example implementations.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges. Further, such communications may be additionally emulated or involve message transfers using an M-CDS device, such as discussed herein, among other examples.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies. In some instances, one or more host devices may be communicatively coupled to an M-CDS device via one or more such wireless network communication channels.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensors, pressure sensors, barometric pressure sensors, and the like. The external interface 470 further may be used to connect the edge device 450 to actuators 474, such as power switches, valve actuators, an audible sound generator, a visual warning device, and the like. External devices may include M-CDS devices and other external devices may be coupled to through an M-CDS, among other example implementations.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

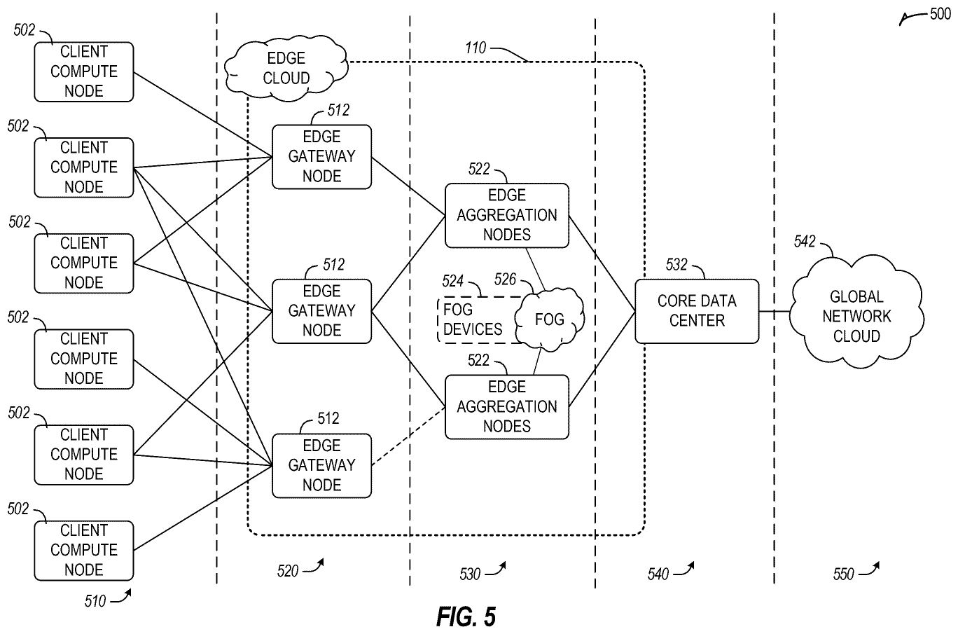

FIG. 5 provides a further abstracted overview of layers of distributed compute, including a data center or cloud and edge computing devices. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 532 may be located within, at, or near the edge cloud 210.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

In some examples, the edge cloud 210 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an loT system arrangement. Other networked, aggregated, and distributed functions may exist in the edge cloud 210 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

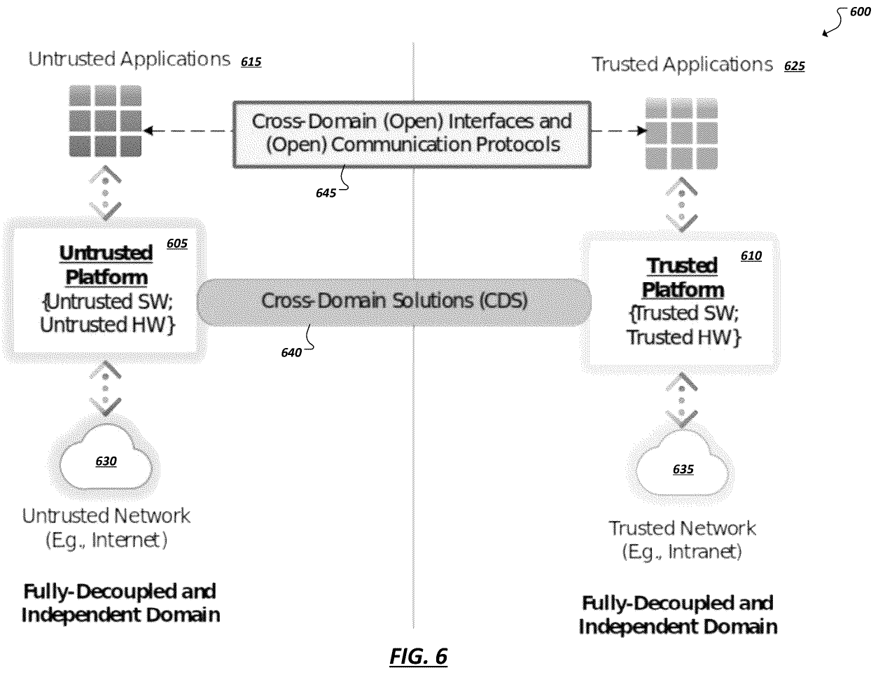

As noted above, M-CDS devices may be deployed within systems to provide secure and custom interfaces between devices (e.g., in different layers) in different domains (e.g., of distinct proprietary networks, different owners, different security or trust levels, etc.) to facilitate the secure exchange of information between the two or more domains. A CDS may function as a secure bridge between different, otherwise independent sources of information, allowing controlled data flow while keeping each domain separate and protected. FIG. 6 is a simplified block diagram 600 illustrating an overview of an example CDS implementation. For instance, two different platforms 605, 610 may be provided, which include respective processing hardware to execute respective operating systems, applications, and other software. One of the platforms (e.g., 605) may be considered an untrusted domain and executed untrusted applications 615 (e.g., based on the lack of security or trust features in its hardware or software, the identity or characteristics of the owner or provider of the platform 605, its coupling to an untrusted or insecure network (e.g., 630), etc.) and another one of the platforms (e.g., 610) may be considered or designated a trusted platform executing trusted applications 625 (e.g., based on the identity of the owner, trust execution features in the hardware and/or software of the domain) and coupled to a trusted network 635). A CDS 640 may be implemented between the platforms 605, 610 to implement a cross-domain interface 645 to enable communication and coordination between the platforms without undermining the independence and distinctive trust levels of the respective domains.

In some implementations, a CDS device provides a controlled interface: It acts as a secure gateway between domains, enforcing specific rules and policies for data access and transfer. This ensures that only authorized information flows in the right direction and at the right level of classification (e.g., to maintain the higher requirements and more demanding policies of the higher security domain). The CDS may enable information exchange by allowing for both manual and automatic data transfer, depending on the specific needs of the domains. This could involve transferring files, streaming data, or even running joint applications across different security levels. The CDS may thus be used to minimize security risks. For instance, by isolating domains and controlling data flow, CDS helps mitigate the risk of unauthorized access, data breaches, and malware infections. This may be especially crucial for protecting sensitive information in government, military, and critical infrastructure settings. The CDS may also be used to assist in enforcing security policies in that the CDS operates based on pre-defined security policies that dictate how data can be accessed, transferred, and sanitized. These policies ensure compliance with regulations and organizational security best practices (e.g., and requirements of the higher-trust domain coupled to the CDS).

CDS devices may be utilized to implement solutions, such as a data diode (e.g., to control the passing of data between applications in different domains (e.g., a microservice in an untrusted domain to a microservice in a trusted domain, etc.). The CDS device may enforce one-way data transfer, for instance, allowing data to only flow from one domain (e.g., a high-security domain) to the other (e.g., a lower-security domain). A CDS device may also be utilized to perform network traffic filtering, for instance, to implement customized firewalls and intrusion detection systems to filter network traffic and block unauthorized access attempts. A CDS device may also perform data sanitization, such as through data masking and redaction, for instance, to remove sensitive information from data (e.g., before it is transferred to a lower-security domain). A CDS device may further implement a security enclaves to provide an isolated virtual environment that can be used to run applications or store sensitive data within a lower-security domain while maintaining a high level of protection, among other examples.

CDS implementations may be used to safeguard sensitive data across various critical sectors, from the high-speed world of automotive engineering to the delicate balance of healthcare information. For instance, CDS may empower secure data exchange in a variety of domains. For example, CDS may benefit automotive applications, such as connected cars, which may assume vehicles exchanging real-time traffic data, safety alerts, and even software updates across different manufacturers and infrastructure providers. CDS may be used in such environments to ensure secure communication between these disparate systems, preventing unauthorized access and protecting critical driving data. Further, in autonomous driving applications, as self-driving cars become reality, CDS may be invaluable for securing communication between sensors, onboard computers, and external infrastructure like traffic lights and V2X (vehicle-to-everything) networks. This ensures reliable data exchange for safe and efficient autonomous driving.

CDS devices may be deployed to enhance computing systems in other example industries and applications. For instance, CDS may be employed within financial applications, such as secure data sharing. For instance, CDS may be used to facilitate secure data exchange between banks, credit bureaus, and other financial institutions, enabling faster loan approvals, better risk assessments, and improved customer service. As another example, CDS may be beneficial within healthcare applications. For instance, CDS may be advantageously applied in maintaining patient data privacy. CDS may be used to help to decouple the data in the healthcare providers and securely share patent data between hospitals, clinics, and pharmacies while complying with strict privacy regulations like HIPAA. This ensures efficient patent care while protecting sensitive medical information. CDS may also be employed within telemedicine and remote monitoring by enabling secure communication between doctors and patients during telemedicine consultations and allows for real-time data transfer from medical devices worn by patients remotely. This improves access to healthcare and allows for proactive intervention in critical situations.

Defense and national security applications may also benefit from platforms including CDS devices. For instance, in intelligence sharing, CDS facilitates secure collaboration and information sharing between different intelligence agencies and military branches. This enables quicker response times to threat and improves overall national security. Further, in systems protecting critical infrastructure, CDS safeguards data from critical infrastructure like power grids, communication networks, and transportation systems against cyber-attacks and unauthorized access. This ensures the smooth operation of these vital systems and protects national security, among other example applications and benefits.

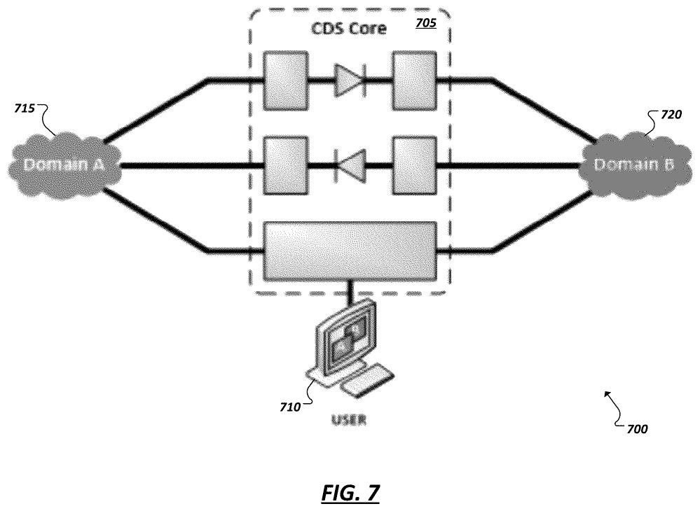

A M-CDS provides a memory-based interface that can be used to transfer the data across multiple hosts in multiple separate domains. The M-CDS device includes a memory to implement a shared memory accessible to two or more other devices coupled to the M-CDS by respective interconnects. The shared memory may implement one or more buffers for the exchange of data between the devices according to customizable policies and/or protocols defined for the shared memory. This common memory space is used to create user-defined buffers to communicate in an inter-process communication manner, but across multiple hosts. Further, logic may be provided in the M-CDS device to perform data masking and filtering of data stored in the buffer (e.g., based on customer-defined policies) so that more fine-grained data control can be performed. As an example, turning to FIG. 7, a simplified block diagram 700 is shown illustrating an example application of a M-CDS device 705. In this example, a user application (e.g., a software-as-a-service (Saas), cloud-based application, etc.) may be implemented (e.g., accessible over a network by one or multiple client devices (e.g., 710)), where the M-CDS device 705 is programmed to implement two shared buffers to enable one-way data exchange between two disparate and independent systems or domains 715, 720. The implementation of the example user application may leverage functionality and/or data provided by and through the cooperation of both of these systems 715, 720. However, due to the independence of the domains 715, 720 (and potentially security, privacy, intellectual property, or other considerations) a direct coupling of the systems 715, 720 may not be possible. In this example, the M-CDS 705 enables custom-defined communication channels through the shared memory buffers, the buffers (in this example) enabled to implement respective unidirectional data channels, or a data diode. In other examples, the same M-CDS device 705 may implement different, customer-defined communication channels through its shared memory and corresponding buffers, including bidirectional communication channels (e.g., using two buffers for each direction). Among the example advantages, an M-CDS device may enable buffers according to flexibly-defined user-defined protocols, custom-defined data formats, non-IP based host-to-host communication, and other communication similar to inter-process communication, but across multiple hosts running over non-IP-networks, among other examples.

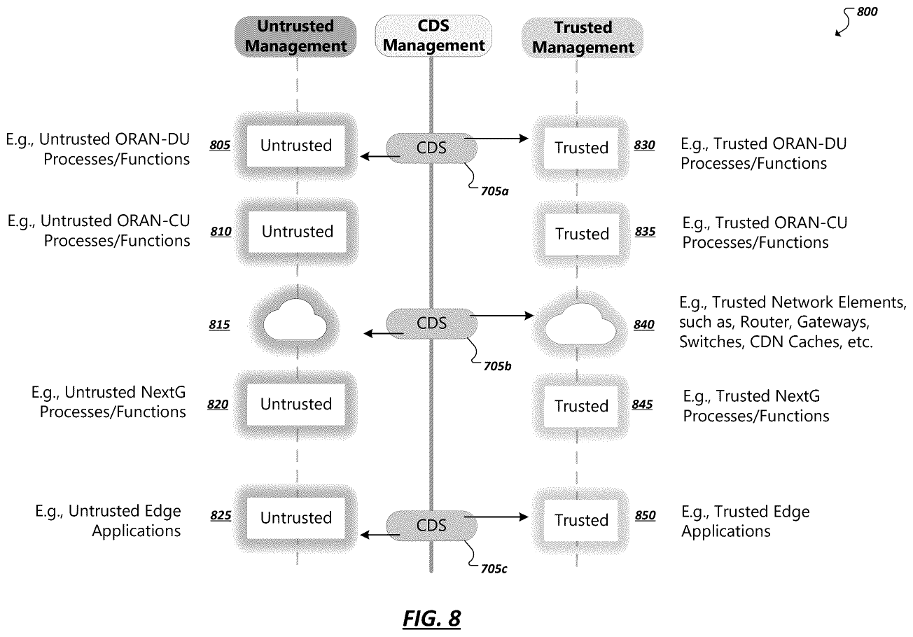

A variety of devices representing independent computing domains may couple to and communicate through an example M-CDS device. FIG. 8 is a simplified block diagram 800 illustrating various solutions utilizing one or more M-CDS devices. For instance, domain devices may include I/O devices (e.g., an FPGA, GPU, storage device, hardware accelerator, which host devices may traditionally access directly via interconnect busses (e.g., PCIe links)), a networking device providing access to an Internet Protocol (IP) IP network (e.g., a virtual or physical network interface card (NIC) that can use a network socket), a memory module that can share the memory space between independent domains that connect to a CDS device (e.g., 705a-c), etc. Some of the domain entities may be regarded as “untrusted” (e.g., based on particular security, privacy, or trust policies and the domain entities failing in one or more regards to meet such policies), while other domain entities couple are regards as “trusted” (e.g., for satisfying the security, privacy, or trust policies), with entities in untrusted domains (e.g., 805, 810, 815, 820, 825, etc.) coupling securely through a M-CDS device 705a-c to the trusted domain entities (e.g., 830, 835, 840, 845, 850, etc.). The shared memory of the M-CDS devices lends enhanced security and control, given its independence from the computing environment domains to which they are coupled to, thereby providing security and isolation as a service to the data being exchanged over the memory-implement interface provided through the M-CDS device.

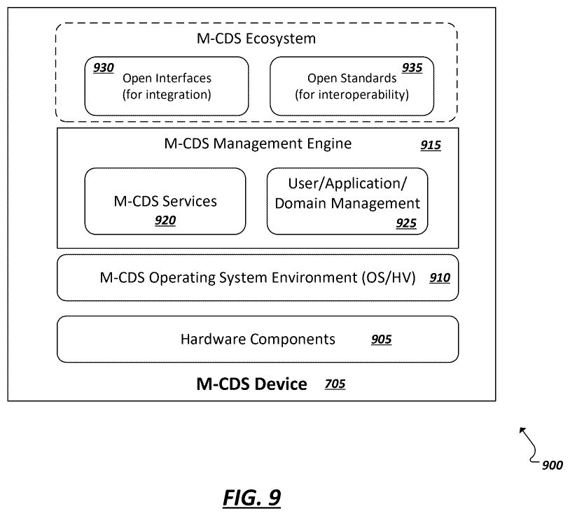

Turning to FIG. 9, a simplified block diagram 900 is shown illustrating an example implementation of an M-CDS device 705. The M-CDS device 705, in this example, may include a variety of hardware components 905 including memory and memory management circuitry, as well as one or more processing elements, including a central processing unit (CPU), hardware accelerators, programmable processor devices, among other examples. In this example, an operating system 910 may run on the M-CDS hardware 905 and support a variety of CDS services and logic implemented on the M-CDS device 705. For instance, a management engine 915 may be implemented to manage memory-based communication channels implemented through the M-CDS device 705. For instance, the management engine 915 may include M-CDS services management 920, including management of the M-CDS device control plane (e.g., to configure the communication channel), M-CDS device data plane (e.g., implementing the communication channel and its constituent policies and protocols), M-CDS device memory management, and the M-CDS databases including records which define the policies, rules, protocols, and configuration of specific M-CDS-implemented communication channels. The management engine 915 may further include management 925 of domains, users, applications, and processes (or communication endpoints), which may couple to the M-CDS device 705 and employ M-CDS device-implemented communication channels, including identifying rules and policies applying to respective endpoints, permission management and authentication of respective endpoints, telemetry reporting, and quality of service (QOS) enforcement, among other examples. One or more multiple communication channels may be established using the logic of the management engine to implement a CDS system that supports channels with multiple different open interfaces 930 and protocol standards 935, which may be custom-configured by the endpoints that are to use the channel.

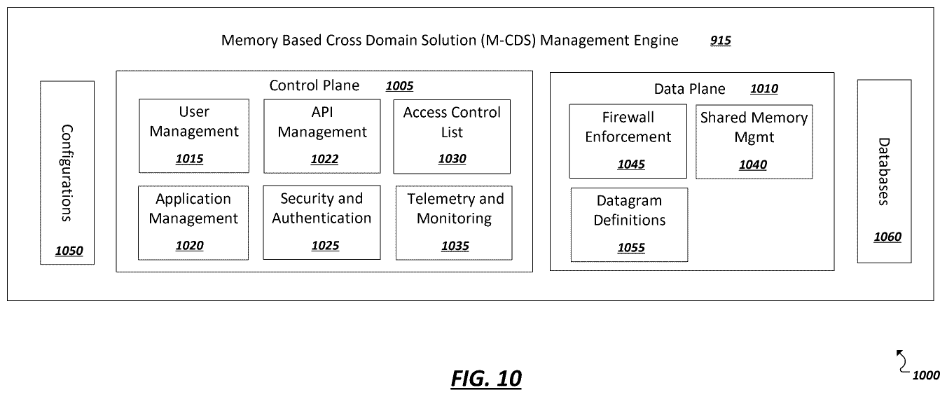

Turning to FIG. 10, a simplified block diagram 1000 illustrating example logical modules of an example M-CDS device, implemented in hardware circuitry, firmware, and/or software executed on the M-CDS device. The management engine 915 may include a control plane manager 1005 and a data plane manager 1010. The control plane manager 1005 may be responsible for managing the configuration and establishment of memory-based communication channels in the M-CDS device. With a channel configured, the data plane management 1010 may manage operation of the channel following configuration, enforcing policies and providing services to be used in the respective CDS channels based on the configurations.

An example M-CDS device may include two or more I/O ports to couple to devices representing different domains. The control plane manager 1005 may interface with the attached devices to present the M-CDS device as a memory device (e.g., RAM device) accessible by the attached devices via their respective interconnect (e.g., a respective PCIe, CXL, Ethernet, or other links). A user manager 1015 may identify a particular device, operating system, hypervisor, etc. of a domain and determine attributes of the corresponding domain, including policies and configurations to be applied for the domain. The user manager 1015 may further identify the various applications (e.g., applications, services, processes, virtual machines, or threads) that are to run on the domain's operating system or hypervisor and that may utilize communication channels implemented by the M-CDS device. An application manager 1020 may identify, for the applications of each domain, attributes, permissions, policies, and preferences for the applications so as to configure the manner in which individual applications will access and use communication channels (and their corresponding buffers) implemented in the M-CDS device. For instance, a single buffer or communication channel configured in the M-CDS to enable communication between two or more domain devices may be called upon, in some implementations, to be used by multiple, distinct applications of a domain, and the application manager 1020 may configure the channel to establish rules and policies that will govern how the applications share the channel, among other example configurations and considerations.

Continuing with the example of FIG. 10, an API manager 1022 may be provided in some implementations to assist in configuring the M-CDS device and respective channels configured in the M-CDS device to interoperate in a system where the M-CDS device couples through an external switch or another M-CDS device to one or more domains, with the communication channel being configured to consider the routing, protocols, and other attributes of the potential one-to-many coupling of the M-CDS device to potentially multiple distinct domains through a single I/O interface of the M-CDS device 705, among other examples. A security and authentication manager 1025 may define and enforce security and authentication protocols (e.g., at the domain or application level) for the channels, such that specific security features and/or policies are configured for the channel. Further, an access control manager 1030 may govern configuration access to the M-CDS device, for instance, enforcing access controls and permissions of the configuration port of the M-CDS device. QoS and telemetry monitoring may also be managed for channels of specific domains and/or applications, for instance, in accordance with QoS guarantees for various domains or applications, and telemetry monitoring access may be controlled using a QoS and telemetry monitoring manager 1035, among other example modules and logical blocks.

The management engine 915 of an example M-CDS device may additionally include data plane management logic 1010 to govern the operation of various communication channels (and corresponding buffers) configured in the memory of the M-CDS device in accordance with the configurations (e.g., 1050) implemented using the control plane manager. Individual buffers and channels may have respective functionality, rules, protocols, and policies defined for the channel, and these channel or buffer definitions may be recorded within a channel database 1060. The data plane manager 1010 may include, for instance, shared memory management engine 1040 to identify a portion of the M-CDS device memory to allocate for a specific communication channel and define pointers to provide to the domain devices that are to communicate over the communication channel to enable the devices' access to the communication channel. The shared memory management engine 1040 may leverage these pointers to effectively “turn off” a device's or application's access and use of the communication channel by retiring the pointer, disabling the device's ability to write data on the buffer (to send data on the communication channel) or read data from a buffer (to receive/retrieve data on the communication channel), among other example functions. Other security and data filtering functions may be available for use in a communication channel, based on the configuration and/or policies applied to the channel, such as firewalling by a firewall manager 1045 (e.g., to enforce policies that limit certain data from being written to or read from the communication channel buffer) or data filtering (e.g., at the field level) performed by a datagram definition manager 1055 that is aware of the data format of data written to or read from the communication channel (e.g., based on a protocol or other datagram format (including proprietary data formats) defined for the channel), to identify the presence of certain sensitive data to filter or redact such data and effectively protect such information from passing over the communication channel (e.g., from a more secure or higher trust domain to a less secure or lower trust domain), among other examples.

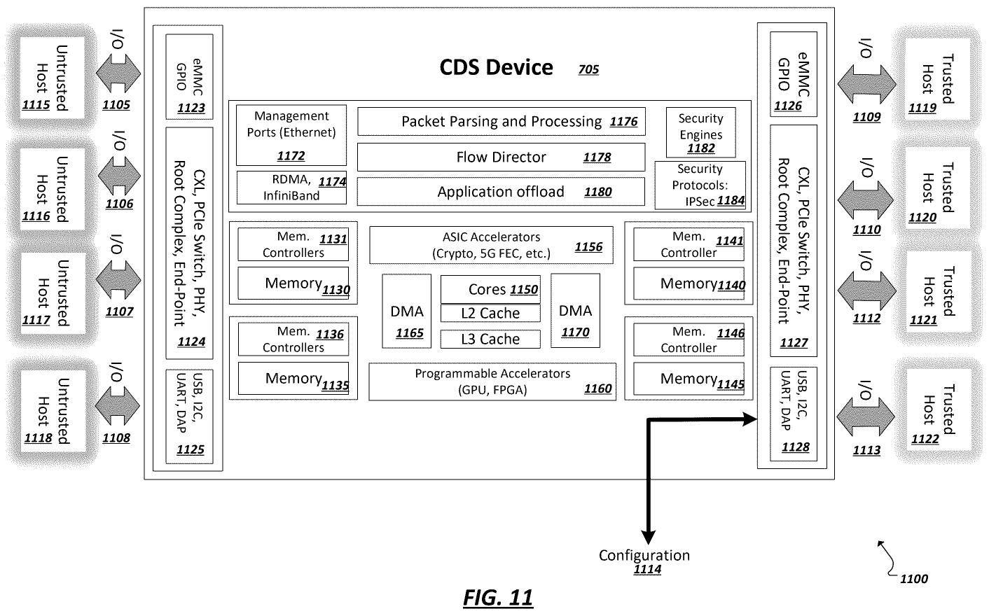

Turning to FIG. 11, a simplified block diagram 1100 is shown illustrating example hardware components of an example M-CDS device 705. An M-CDS device 705 includes two or more ports (e.g., 1105-1113) to couple to various host devices (e.g., 1115-1123) associated with two or more different domains (e.g., domains of different ownership, trust levels, security features or permissions, etc.). Different interconnect protocols may be supported by the various ports 1105-1113 of the M-CDS device 705 (such as PCIe, CXL, Ethernet, UPI, UCle, NVLink, etc.) and corresponding protocol logic (e.g., 1124-1129) may be provided on the M-CDS device 705 to enable the M-CDS device to connect to, train, and communicate with the host devices (e.g., 1115-1123) over corresponding links. One of the ports or an additional port may be provided as a configuration channel 1114, to enable a user or system to interface with the M-CDS device 705 and configure functionality of the M-CDS device 705, define configurations for connections and communication with the M-CDS device 705 (e.g., by host devices 1115-1122), define policies and rules that may be applied to memory-based communication channels implemented on the M-CDS device 705, configure CDS services provided by through the hardware, firmware, and/or software executed on the M-CDS device 705, among other example features.

The M-CDS device 705 also includes one or more memory elements (e.g., 1130, 1135, 1140, 1145), at least a portion of which are offered as shared memory and implement communication buffers through which buffer schemes may be applied to implement communication channels between two or more hosts (e.g., 1115-1123) through the exchange of data over the buffer(s). The portions of memory 1130, 1135, 1140, 1145 designated for use as shared memory may be presented by the M-CDS device 705 to the host devices (e.g., 1115-1122) as shared memory (e.g., using semantics of the corresponding interconnect protocol through which the host device connects to the M-CDS device 705). Corresponding memory controllers (e.g., 1131, 1136, 1141, 1146, etc.) may be provided to perform memory operations on the respective memory elements (e.g., 1130, 1135, 1140, 1145). The M-CDS device 705 may further include direct memory access (DMA) engines (e.g., 1165, 1170) to enable direct memory access (e.g., DMA reads and writes) by hosts (e.g., 1115-1122) coupled to the M-CDS device 705 and utilizing buffers for communication channels as implemented in the shared memory regions of the M-CDS memory (e.g., 1130, 1135, 1140, 1145).

One or more CPU processor cores (e.g., 1150) may be provided on the M-CDS device 705 to execute instructions and processes to implement the communication channel buffer and provide various CDS services in connection with these buffers (e.g., based on the respective configuration, rules, and policies defined for the buffer). Corresponding cache may be provided, and the processor cores 1150 may cooperate and interoperate with other processing elements provided on the M-CDS device 705, including ASIC accelerator devices 1155 (e.g., cryptographic accelerators, error correction and detection accelerators, etc.) and various programmable hardware accelerators 1160 (e.g., graphics accelerators (e.g., CPU), networking accelerators, machine learning accelerators, matrix arithmetic accelerators, field programmable gate array (FPGA)-based accelerators, etc.). Specialized processing functionality and acceleration capabilities (e.g., provided by hardware accelerators 1155, 1160, etc. on the M-CDS device 705) may be leveraged in the buffer-based communication channels provided through the memory of the M-CDS device 705, based on configurations and rules defined for the channel.

Logic may be provided on the M-CDS device 705 to implement various CDS services in connection with the buffer-based communication channels provided on the M-CDS device 705. Such logic may be implemented in hardware circuitry (e.g., of accelerator devices (e.g., 1155, 1160), functional IP blocks, etc.), firmware or software (e.g., executed by the CPU cores 1150). Functional CDS modules may thereby be implemented, such as modules that assist in emulating particular protocols, corresponding packet processing, and protocol features in a given buffer channel (e.g., providing Ethernet-specific features (e.g., Dynamic Host Configuration Protocol (DHCP)), etc.) using an Ethernet port management module, or RDMA and InfiniBand features using a RDMA and/or InfiniBand module (e.g., 1174). Various packet parsing and processing may be performed at the M-CDS device 705 using a packet parsing module 1176, for instance, to parse packets written to a communication channel buffer and performing additional services on the packet to modify the packet or prepare the packet for reading by the other device coupled to the communication channel buffer. Application management tasks may also be performed, including routing tasks (e.g., using a flow director 1178) to influence the manner in which data communicated over a buffer is consumed and routed by the domain receiving the data (e.g., specifying a process, core, VM, etc. on the domain device that should handle further processing of the data (e.g., based on packet inspection performed at the M-CDS device 705), among other examples). An application offload module 1180 may be leverage information concerning a network connection of one of the devices coupled to the M-CDS device 705 to cause data read by the device to be forwarded in a particular manner on a network interface controller or other network element on the device (e.g., to further forward the data communicated over the M-CDS device 705 communication channel to other devices over the network). In still other examples, the M-CDS device 705 may perform various security services on data written and/or read from a communication channel buffer implemented on the M-CDS device 705, for instance, applying custom or pre-defined security policies or tasks (e.g., using a security engine 1182), applying particular security protocols to the communications carried over the communication channel buffer (e.g., IPSec using a security protocol module 1184), among other example CDS services and functionality.

As introduced above, a traditional IP network may be at least partially replaced using one or more (or a network of) M-CDS devices. M-CDS devices may be utilized to implement cross-domain collaboration that allows information sharing to become more intent-centric. For instance, one or more applications executed in a first domain and the transactions required for communications with other applications of a different domain may be first verified for authenticity, security, or other attributes (e.g., based on an application's or domain's requirements), thereby enforcing implicit security. Memory-based communication may also offer a more reliable data transfer and simpler protocol operations for retransmissions and data tracking (e.g., than a more convention data transfer over a network or interconnect link (which may be emulated by the memory-based communication). Through such simpler operations, M-CDS solutions can offer high-performance communication techniques between interconnecting domain-specific computing environments. Further, the memory interfaces in an M-CDS device may be enforced with access controls and policies for secure operations, such as an enabling a data-diode which offers communications in a unidirectional fashion with access controls, such as write-only, read-only, and read/write permitted. In other instances, the memory-based communication interface may enable bi-directional communication between different domains. In some implementations, separate buffers (and buffer schemes) may be used to facilitate each direction of communication (e.g., one buffer for communication from domain A to domain B and another buffer for communication from domain B to domain A). In such cases, different policies, CDS services, and even protocols may be applied to each buffer, based on the disparate characteristics and requirements of the two domains, among other example implementations. Generally, these memory-based communication interfaces can be a standard implementation and may also be open-sourced for easier use, community adoption, and public participation in technology contributions without compromising the security and isolation properties of the data transactions. The open implementation also provides transparency of communication procedures over open interfaces to identify any security vulnerabilities.

Traditional communication channels may utilize protocols, which define at least some constraints and costs in achieving compatibility between the connected devices and applications that are to communicate over the channel. An M-CDS may enable support for application-defined communication protocols over open interface definitions (and open implementation), allowing customized communication solutions, which are wholly independent of or at least partially based on (and emulate) traditional interconnect protocols. For instance, application-defined communication protocols may enable applications to create their own datagram format, segmentation, encryption, and flow control mechanisms that are decoupled from the protocols used in the M-CDS interfaces (connecting the M-CDS device to host devices) and memory buffers. In some instances, an M-CDS solution only provides the domain systems with physical memory space to communicate and allows the domain systems to specify and define how the systems will communicate over M-CDS memory, with the M-CDS device providing logic that may be invoked by the application-specific definition to perform and enforce specified policies or features desired by the domain systems,, among other examples.

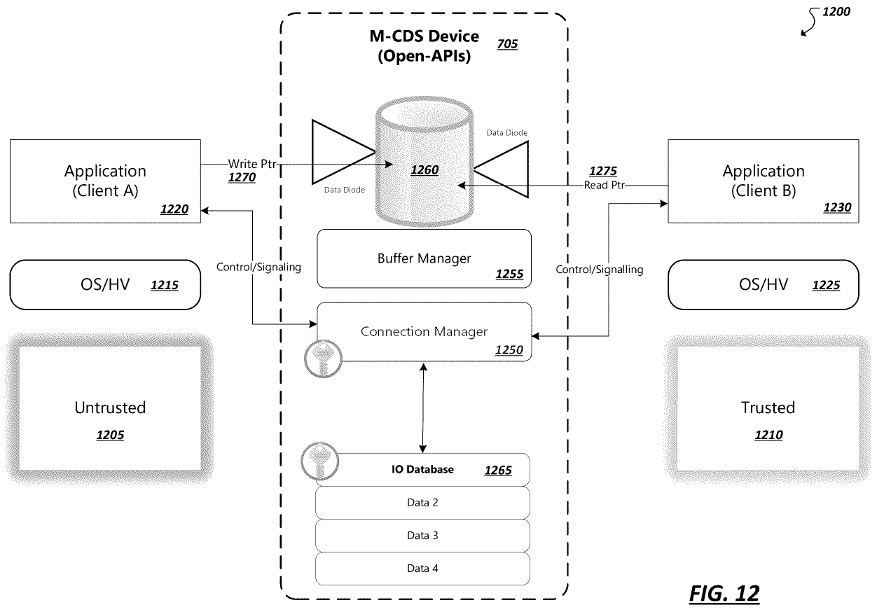

An example M-CDS device may be utilized to implement an M-CDS-based I/O framework (IOFW). The M-CDS device may be incorporated into a system such as that illustrated in the example of FIG. 12. FIG. 12 shows a simplified block diagram 1200 of the system, including an M-CDS device 705 coupled to a first client 1220 (associated with an untrusted domain 1205) and a second client 1230 (associated with a different, trusted domain 1210). In this example, the clients 1220, 1230 may be respective applications run in corresponding operating environments 1215, 1225 (e.g., respective operating systems, hypervisors, containers, etc.) associated with domains 1205, 1210. In other cases, clients may be other types of processes, services, threads, or other software entities. The clients (e.g., 1220, 1230), although provided through independent and disparate domains (e.g., 1205, 1210) may nonetheless be beneficially coupled using an M-CDS to allow the clients to co-function and provide a beneficial service or function (e.g., implement a security application, a defense application, an automotive application, a healthcare application, or a financial application, among other examples.

An IOFW provides a framework for software components in the respective domains of computing nodes to interface with shared memory based inter-process communication (IPC) channels, which are either physical or virtual functions, in a uniform and scalable manner. More specifically, an IOFW provides a framework for establishing and operating a link between any two functional software modules or clients (e.g., applications, drivers, kernel modules, etc.) belonging, in some cases, to independent domains of computing nodes. As an example, a process A (e.g., 1220) of domain X (e.g., 1205) may be linked with a process B (e.g., 1230) of domain Y (e.g., 1210) via a communication channel implemented on a M-CDS device 705. While clients communicating over an IOFW of an M-CDS device, may, in many cases, belong to independent domains (e.g., of independent computing nodes), communication over an M-CDS device (e.g., 705) is not limited to clients operating in different domains. For instance, two clients can belong to the same domain or different domains. An M-CDS device 705 may implement an IOFW that provides a mechanism for setting up both an end-to-end connection and a communication channel buffer (e.g., according to a buffer scheme definition) to support data transfer. To implement the IOFW, an M-CDS device 705 may decouple control (e.g., for connection setup) from the data plane (e.g., for data transfer).

Continuing with the example of FIG. 12, in some implementations, an example M-CDS device 705 may include a connection manager 1250 and a buffer manager 1260, the connection manager 1250 embodying those hardware and logical elements of the M-CDS device 705 that are to implement the control plane of the connection (e.g., to establish and configure the communication channel) and the buffer manager 1255 implementing the data plane using a buffer 1260 implemented in the shared memory of the M-CDS device 705. The connection manager 1250 may interface with respective host devices and clients (e.g., 1220, 1230) to identify requirements, policies, and schemes for a communication channel to be implemented between the clients. The connection manager 1250 may coordinate the negotiation, configurations, and opening of the channel, allowing communication to commence over a buffer implemented in the M-CDS device shared memory that is sized and governed in accordance with the configuration determined using the connection manager 1250. Policies, client identities, protocol definitions, and buffer schemes may be maintained in a database 1265.

In some implementations, an M-CDS device connection manager facilitates the connection setup between clients. Each client (e.g., 1220, 1230) may be expected to request a desired buffer scheme for transmission and receiving, respectively, along with the target clients for the connections. The connection manager 1250, in coordination with the M-CDS database 1265, permits the requested connection by setting up the buffer schemes that will govern the buffers (e.g., 1260) implemented in the M-CDS shared memory to implement a communication channel between the clients (e.g., 1220, 1230). Once the connection is set up, the connections' states, along with tracking information, may be updated to the database 1265 (among other information) to keep the real-time IOFW statistics for the connection (e.g., which may be used by the buffer manager 1255 in connection with various CDS services (e.g., QoS management) provided for the channel). The connection manager 1250 allows the handover of channel ownership so that connection services can be offloaded to other clients (e.g., other services or threads) as permitted by the security policies or other policies of the respective computing domains (e.g., 1205, 1210). The connection manager 1250 may allow suspension of the active connection between two channels (e.g., two channels between clients A and B) to establish a new active connection with another client (e.g., between client A and another client C). In this example, when clients A and B want the resumption of service, the connection between clients A and B can be resumed without losing the previous states of the previously established channels (e.g., during the suspension of the connection between clients A and B), while operating the connection in the M-CDS device 705 between clients A and C, among other illustrative examples. Similar to the client registration for setting up the buffer schemes, the connection manager 1250 may also facilitate the de-registration of channels by one or more of the involved clients, to retire or disable a corresponding buffer, among other examples.

In some implementations, the buffer manager 1255 provides the framework for creating new buffer schemes to define communication channel buffers for use in implementing M-CDS communication channels. Defined buffer schemes may be stored, for instance, in database 1265 and may be recalled to work as a plugin in subsequent communication channels. Buffer schemes may also be configured dynamically. The buffer manager may support various buffer schemes which suit the unique requirements of the clients and new buffer schemes may be introduced to register at run-time. A variety of buffer attributes (e.g., buffer type, buffer size, datagram definitions, protocol definition, policies, permissions, CDS services, etc.) may be specified for a buffer in a buffer scheme and potentially limitless varieties of buffers schemes and buffers may be implemented to scale an IOFW platform for new future requirements corresponding to future clients, such as buffer features supporting Time Sensitive Networking (TSN) Ethernet, Dynamic Voltage and Frequency Scaling (DVFS), global positioning system (GPS) timing use cases to share across domains, among a myriad of other example features.

Buffer schemes define the attributes of a buffer to be implemented within the shared memory of a M-CDS device. A defined buffer handles the movement of data in and out of shared memory, thereby allowing clients (e.g., 1220, 1230) with access to the buffer (e.g., 1260) to exchange data. The buffer 1260 may be configured and managed (e.g., using the buffer manager 1255) to emulate traditional communication channels and provide auto-conversion of schemes between the transmit function of one client (e.g., 1220) to the receive function of the corresponding other client (e.g., 1230) coupled through the buffer 1260. In some implementations, within a buffer, clients (e.g., 1220, 1230) can choose different buffer schemes, for example, a data Multiplexer (MUX) can read data in a serial stream and output high-level data link control (HDLC) frames in a packet stream. On the contrary, a data serializer may convert the parallel data stream to the serial stream using a buffer according to a corresponding buffer scheme. Conversion from one buffer scheme to another may also be supported. For example, an existing or prior buffer scheme that is configured for serial data transmission may be converted to instead support packet data, among other examples. In some implementations, the buffer scheme defines or is based on a communication protocol and/or datagram format. The protocol and data format may be based on an interconnect protocol standard in some instance, with the resulting buffer and M-CDS channel functioning to replace or emulate communications over a conventional interconnect bus based on the protocol. In other instances, a buffer scheme may be defined according to a custom protocol with a custom-defined datagram format (e.g., a custom packet, flit, message, etc.), and the resulting buffer may be sized and implemented (e.g., with corresponding rules, policies, state machine, etc.) according to the custom protocol. For instance, a buffer scheme may define how the uplink and downlink status is to be handled in the buffer (e.g., using the buffer manager). In some instances, standard services and policies may be employed to or may be offered for use in any of the buffers implemented in the M-CDS device to assist in the general operation of the buffer-implemented communication channels. As an example, a standard flow control, load balancing, and/or back-pressuring scheme may be implemented (e.g., as a default) to the data and/or control messages (including client-specific notification schemes) to be communicated over the buffer channel, among other examples.

The database 1265 may be utilized to store a variety of configuration information, policies, protocol definitions, datagram definitions, buffer schemes, and other information for use in implementing buffers, including recalling previously used buffers. For instance, database 1265 may be used for connection management in the M-CDS device 705 to facilitate connection setup, tracking of connection states, traffic monitoring, statistics tracking, and policy enforcement of each active connection. Indeed, multiple concurrent buffers of varying configurations (based on corresponding buffer schemes) may be implemented concurrently in the shared memory of the M-CDS device 705 to implement multiple different concurrent memory-based communication channels between various applications, processes, services, and/or threads hosted on two or more hosts. The database 1265 may also store all information about authorized connections, security policies, and access controls, etc. used in the establishing the connections with the channels. Accordingly, the connection manager 1250 may access the database 1265 to save client-specific information along with connection associations. The access to the connection manager in the M-CDS device 705 may be enabled through the control plane of the CDS ecosystem, independent of the host node domains (of hosts coupled to the M-CDS device 705), among other example features.

In some implementations, an M-CDS device may support direct memory transactions (DMT) where the direct mapping of address spaces are directly between independent domains coupled to the M-CDS device such that applications can directly communicate over shared address domains via the M-CDS device. Further, Zero-Copy Transactions (ZCT) may be supported using the M-CDS DMA engine to allow the M-CDS device to be leveraged as a “data mover” between two domains where the M-CDS DMA function operates to move data between two domains (through the independent M-CDS device 705) without requiring any copies into the M-CDS local memory. For instance, the DMA of the M-CDS device 705 transfers the data from the input buffer of one client (e.g., Client A (of domain X)) to the output buffer of a second client (e.g., Client B (of domain Y)). The M-CDS device may also implement packet based transactions (PBT), where the M-CDS device exposes the M-CDS interfaces as a virtual network interface to the connecting domains such that the applications in their respective domains can use the traditional IP network to communicate over TCP or UDP sockets using the virtual network interface offered by the M-CDS services (e.g., by implementing a first-in first-out (FIFO) queue in the shared memory of the M-CDS device) with normal packet switching functionalities, among other examples.

The M-CDS device may enforce various rules, protocols, and policies within a given buffer implemented according to a corresponding buffer scheme and operating to facilitate communication between two domains coupled to the M-CDS device. As an example, in some instances, the M-CDS device 705 may enforce unidirectional communication traffic in a buffer, by configuring the buffer such that one of the device is permitted read-only access to data written in the buffer, while the other device (the sender) may write (and potentially also read) data to the buffer. Participating systems in an M-CDS communication channel may be provided with a pointer or other memory identification structure (e.g., a write pointer 1270, a read pointer 1275, etc.) to identify the location (e.g., using an address alias in the client's address space) of the buffer in the M-CDS memory (e.g., and a next entry in the buffer) to which a given client is granted access for cross-domain communication. Access to the buffer may be controlled by the M-CDS device 705 by invalidating a pointer (e.g., 1270, 1275) thereby cancelling a corresponding client's access to the buffer (e.g., based on a policy violation, a security issue, end of a communication session, etc.). Further, logic of the M-CDS device 705 may allow data written to the buffer to be modified, redacted, or censored based on the M-CDS device's understanding of the datagram format (e.g., and its constituent fields), as recorded in the database 1265. For instance, data written by a client (e.g., 1230) in a trusted domain may include information (e.g., a social security number, credit card number, demographic information, proprietary data, etc.) that should not be shared with an untrusted domain's clients (e.g., 1220). Based on a policy defined for a channel implemented by buffer 1260, the M-CDS device 705 (e.g., through buffer manager 1255) may limit the untrusted client 1220 from reading one or more fields (e.g., based on these fields identified as including sensitive information) of data written to the buffer 1260 by the trusted application 1230, for instance, by omitting this data in the read return or modifying, redacting, or otherwise obscuring these fields from the read return, among other examples.

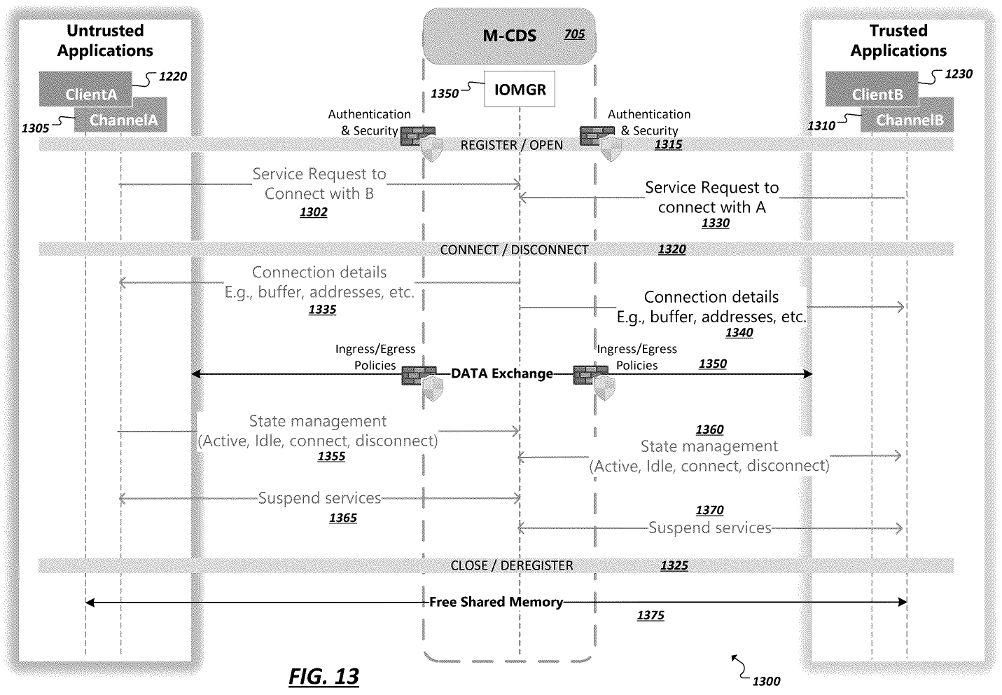

FIG. 13 is a flow diagram 1300 illustrating an overview of the example end-to-end M-CDS operation for two clients, namely client A 1220 and client B 1230, belonging to untrusted 1205 and trusted 1210 domains, respectively, utilizing a M-CDS device 705 for the I/O framework. In this example, client A 1220 sends a request 1302 to the M-CDS device 705 to establish a connection with client B 1230 through the connection manager 1250 of the M-CDS device 705. In some implementations, the flow may be similar to Inter Process Communication (IPC) over shared memory, however the operations over M-CDS involve multiple operating system (OS) domains, and hence require coordination of resources, buffer, and connection management as an independent function of the M-CDS solution. For instance, a Registration phase 1315 may be utilized to register each of the participating clients (e.g., 1220, 1230) with the connection manager 1250, a Connection State Management phase 1320 to control the memory-based links status (e.g., to move between active and deactivated (or idle) link states), and a Deregistration phase 1325 to tear down (or retire) the buffers established in the M-CDS device memory for the link and completing deregistration of the communication channels (e.g., 1305, 1310) of the clients (e.g., 1220, 1230) (e.g., to free up the shared memory for other buffers and communication channels between clients on different domains).

In one example, a Registration phase 1315 may include requests by each of the two or more clients (e.g., 1220, 1230) that intend to communicate on the M-CDS communication channel, where the clients send respective requests (e.g., 1302, 1330) registering their intent to communicate with other clients with the M-CDS 705. The connection manager 1250 may access and verify the clients' respective credentials and purpose of communication (e.g., using information included in the requests and validating this information against information included in the M-CDS database). For instance, an authentication may be performed using the M-CDS-control plane before a given client is permitted to establish communication links over M-CDS memory interfaces. Each established communication link that is specific to the client-to-client connection may be referred to as a “memory channel” (e.g., 1305, 1310). Further, admission policies may be applied to each client 1220, 1230 by the connection manager 1250. In some implementations, the Registration phase 1315 may include an IO Open function performed by the M-CDS device 705 to enables the creation of memory channels (e.g., 1305, 1310) dedicated to each communication link of the pair of clients, in the case of unicast transactions. In the case of multicast/broadcast transactions, the M-CDS device 705 registers two or more clients and acts as a hub where the data from at least one source client (writing the data to the buffer) are duplicated in all the received buffers granted access to the respective destination clients registered on these channels, among other examples.

In a Connection State Management phase 1320 an IO Connect function may be performed by the connection manager 1250 to notify all of the clients registered for a given communication channel to enter and remain in an active state for the transmission and/or reception of data on the communication channel. While in an active state, clients may be expected to be able to write data to the buffer (where the client has write-access) and monitor the buffer for opportunities to read data from the buffer (to receive the written data as a transmission from another one of the registered clients). In some instances, a client can register, but choose not to send any data while it waits for a requirement or event (e.g., associated with an application or process of the client). During this phase, a client can delay the IO Connect signaling after the registration process. Once an IO Connect is successful, then the receiving client(s) is considered ready to process the buffer (e.g., with a closed-loop flow control mechanism). Data may then be exchanged 1335.

The Connection State Management phase 1320 may also include an IO Disconnect function. In contrast to IO Connect, in IO Disconnect, the connection manager 1250 notifies all clients (e.g., 1220, 1230) involved in a specific memory channel to transition to inactive state and wait until another IO Connect is initiated to notify all clients to transition back to the active state. During the lifetime of client-to-client communication session over M-CDS, each participating client (e.g., 1220, 1230) in a memory channel can potentially transition multiple times between active and inactive states according to data transfer requirements of the interactions and transactions between the clients and their respective applications.

A Deregistration phase 1325 may include an IO Close function. In contrast to IO Open, the IO Close function tears down or retires the memory reservations of the memory communication channels used to implement the buffers configured for the channel. A client can still be in the registered state, but the connection manager 1250 can close the memory communication channels to delete all the buffers that have been associated with the memory channels in order to free up the limited memory for other clients to use. Should a change in the activity or needs of the clients change, in some implementations, the memory communication channels may be reopened (through another IO Open function), before the client are deregistered. The Deregistration phase 1325 also includes an IO Deregister function to perform the deregistration. For instance, in contrast to IO Register, IO Deregister is used by the clients to indicate their intent to M-CDS device to disassociate with other client(s) and the M-CDS itself (e.g., at least for a period of time until another instance of the client is deployed and is to use the M-CDS). In the IO Deregister function, the M-CDS device clears the client's current credentials, memory identifiers (e.g., pointers), and other memory channel-related data (e.g., clearing such information from the M-CDS device database), among other examples.

In some implementations, CDS-based systems may be implemented in multi-domain systems, where three or more domains (e.g., of varying trust levels and domain owners) may interconnect with one another through one or more CDS devices (e.g., implemented in an interconnect fabric of CDS devices). Increasing numbers of independent domains may complicate an implementation where CDS-implemented security is to be provided for information exchange among the domains. The strict isolation enforced by an M-CDS device may involve maintaining and enforcing various policies, domain and client authentications, and multiple different buffer schemes to accommodate the varied connections between the domains. Direct connections between systems in different domains (e.g., in different security zones) may become cumbersome, and imprudent configuration and management of the CDS schemas can result in data filtering unintentionally restricting the flow of critical information. Additionally, managing security policies and data translation across various combinations of domains with differing classifications may add complexity, for instance, where data from one source domain is to be sent and shared with multiple different destination domains, among other example issues. For instance, domains and applications may have pre-defined rules based on data type, source, or other criteria to determine whether data that is to pass through a CDS-implemented data diode is to be allowed to pass (e.g., based on whether the data is high or low sensitivity, confidential, etc.).

Standardizing data classification with a CDS implementation may be particularly beneficial in ensuring data security while improving efficiency, enabling collaboration, complying with regulations, and enabling advance analytics capabilities through a CDS implementation. For instance, standard or otherwise consistent data classification and labeling for the CDS may create a shared language for understanding data sensitivity across domains, facilitating secure and efficient data processing in complex cross-domain environments, among other example benefits. In some instances, manual data classification may be utilized with users manually labeling data based on their understanding of it. Metadata may also be used, in some implementations, for classification, with metadata tags appended to the data, for instance, indicating its classification (e.g., high or low sensitivity, etc.). Further, with developments in machine learning, machine-learning inference and classifiers may be utilized to classify data (e.g., and generate metadata to be appended to the data) to more automatically classify data, among other example approaches.

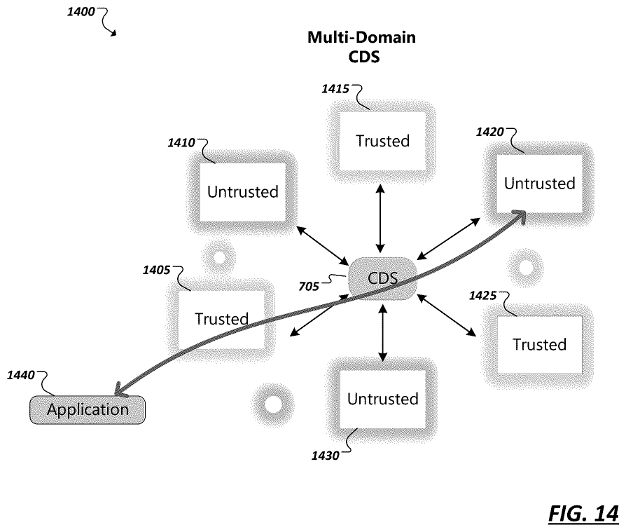

In some implementations, to address these example issues (and others), a CDS device may be utilized to implement a publish-subscribe architecture between source and destination clients coupled to the CDS in a multi-domain environment and thereby allow applications executed in corresponding independent domains to exchange data between trusted and untrusted domains in a controlled and streamlined manner. Simplifying or standardizing the data classification approach can assist in ensuring that the CDS consistently directs received data to the appropriate buffer channels and thereby directs the data to the correct processing or destination domains. FIG. 14 is a simplified block diagram 1400 illustrating an example system including multiple different domains 1405, 1410, 1415, 1420, 1425, 1430 coupled to a CDS 705. Within the context and policies applicable to a given application 1440 (e.g., executed on or accessible through a given one of the trusted domains (e.g., 1405)), some of the domains may be considered trusted (e.g., 1405, 1415, 1425, etc.), while others are considered untrusted (e.g., 1410, 1420, 1430, etc.). The application 1440 can be a source and/or destination of data and the CDS 705 may be used to control which data from the application 1440 is allowed to pass to other domains (e.g., forcing data sourced from the application 1440 to only pass to trusted domains (e.g., 1405, 1415, 1425, etc.) or filtering the data so that only select data (e.g., low sensitivity, unclassified, public, etc.) is allowed to be passed to the untrusted domains, etc.) and which data is allowed to be passed to the application 1440 (e.g., filtering data from untrusted domains to ensure that only appropriate data is passed to the application 1440 through the CDS 705, among other examples.

In situations such as that shown in the example of FIG. 14, a publish-subscribe model may be adopted at the CDS 705 to simplify and standardize the classification and filtering of data at the CDS for a given application or use case. For instance, use cases may include loT data exchange (e.g., where sensor data is to be sent securely from untrusted devices to trusted analytics platforms), healthcare data sharing (e.g., sharing patient data between hospitals, testing laboratories, various cooperating healthcare providers, research institutions, etc. while maintaining strict privacy and security), financial data exchange (e.g., to facilitate secure communication between banks and other financial institutions), government data collaboration (e.g., allowing government agencies or military units to share classified information with authorized partners), artificial intelligence inference and training (e.g., where inference tasks and/or model training workloads may be shared across multiple systems), among other examples.

Maintaining a consistent separation and filtering of data at a CDS may reduce security risks by minimizing the attack surface and potential damage from security breaches. Improved regulatory compliance may be achieved by assisting organizations comply with data privacy regulations. Such multi-domain CDS environments may enable enhanced collaboration between entities and systems without compromising security or regulatory compliance. Further, adopting a publish-subscribe paradigm within such CDS implementations may streamline assignment and authentication processes, among other data management tasks. Additionally, a multi-domain CDS publish-subscribe implementation may provide convenient decoupling of publishers and subscribers (e.g., where publishers and subscribers do not need to know about each other directly, thereby simplifying development and scalability), flexibility in collaboration (e.g., where subscribers are able to potentially subscribe to any number of channels, allowing them to receive relevant data without needing to know all potential sources), dynamic routing at the CDS (e.g., where data may be effectively routed on the basis of topics, enabling flexible distribution across domains without pre-defined connections), and scalability (e.g., with a CDS system able to easily handle a large number of publishers and subscribers due to decoupling and dynamic routing), among other example benefits.

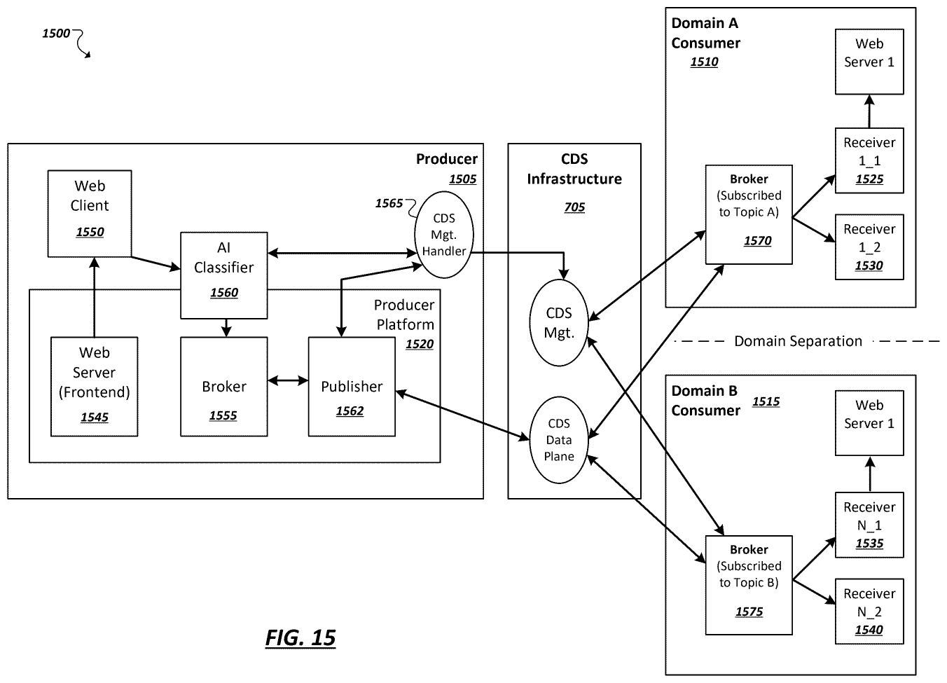

Turning to FIG. 15, a simplified block diagram 1500 is shown illustrating an example implementation of a system utilizing an M-CDS device 705 (or network of M-CDS devices) to implement a publish-subscribe distribution from one or more source (or publisher) domains (e.g., 1505) to multiple destination (or subscriber) domains (e.g., 1510, 1515) with potentially different trust levels. The M-CDS device 705 is to enforce security policies at the domain level based on policies and rules provided by each domain system. Managing and coordinating the varied rules that may be provided by various domains (and even individual applications) may be challenging and contradictory to integrate within a multi-domain use case, where ultimately the rules are by-products of the domain designers' individual interpretations and implementations. The CDS 705 may provide centralized policy enforcement and thereby implement a central broker within a publish-subscribe model and a single point of control. The M-CDS device 705 may function as a broker understanding the various classification levels and access permissions for all data flowing through the system. This ensures consistent and accurate enforcement, regardless of the specific domain a message originates from or is destined for.

As shown in the example of FIG. 15, a publisher 1505 may include an application or platform 1520 that generates data that may be of interest to, for consumption, or otherwise for use by various receiver applications (e.g., 1525, 1530, 1535, 1540) hosted by various domains (e.g., 1510, 1515) of various trust levels. The publisher application 1520 may assemble, collect, or otherwise generate data for publication utilizing a variety of techniques and models. In the particular example of FIG. 15, the publication application 1520 may include a webserver backend 1545, which may interface with a web client 1550 to collect data produced or provided through the client 1550 (e.g., a sensor device, a user endpoint, or other client). In some instances, multiple clients (e.g., 1550) may connect to and provide data (effectively as publishers) to the webserver 1545. The publication application 1520 may further include a broker module 1555 (e.g., compatible with a Message Queuing Telemetry Transport (MQTT) protocol), which organizes data that is to be sent from the application 1520 (e.g., onto a network) by topic, which subscribers (e.g., receivers 1525, 1530, 1535, 1540, etc.) may subscribe to and thereby receive corresponding messages/data designated as belonging to the topic. In this example, classification of the data into topics may be performed using a machine-learning- or Al-based classifier engine 1560. For instance, topics may be used, which correspond to sensitive data (e.g., high sensitivity) and lower-sensitivity data (e.g., low sensitivity). Data generated by the clients or backend may be processed by the classifier 1560 to determine if the data includes confidential, classified, protected, or otherwise sensitive information and automatically classified by the classifier 1560 as belonging to the high or low sensitivity topic.

In the example of FIG. 15, the application 1520 may include a publisher module 1562 to interface with a CDS management handler 1565 may be provided to facilitate connection and coordination with M-CDS device 705 (e.g., to interface with the control plane of the M-CDS and coordinate the transfer of data to and from the shared memory of the M-CDS device). In one example, among the buffers created in the shared memory of the M-CDS device, buffers may be configured to handle data transfers of data assigned a given topic. For instance, data may be tagged to indicate one (or multiple) topics or classifications that are to be associated with the data (e.g., based on a classification performed by classifier engine 1560. The data may be written to that M-CDS buffer corresponding to the topic (and potentially copied to multiple buffers if multiple topics have been applied to the data). As in other examples, the M-CDS device may utilize the respective topic buffers to implement data diodes or one-way data channels that only permit data transfers (e.g., writes and reads from the buffer) by authorized domains and involving data assigned to the buffer's corresponding topic.

Within the context of a publish-subscribe model, for a topic-specific buffer channel implemented in the M-CDS device, a subscriber or subscriber broker (e.g., 1570, 1575) may be authorized to receive data on the topic-specific buffer channel to “subscribe” to the topic channel. In some implementations, multiple subscriber devices (e.g., corresponding to one or multiple domains) may be authenticated to and connected to the buffer channel in the M-CDS device. In other instances, a single subscriber device (e.g., 1570) is coupled to the buffer channel as the receiving domain for a given topic. The subscriber (e.g., 1570) may then push messages or data to multiple subscriber applications or services (e.g., 1525, 1530), which have subscribed to the topic. For subscribers of other topics, a subscriber broker (e.g., 1575) may connect to the corresponding topic buffer channel in the M-CDS device and distribute the data to subscribers (e.g., 1535, 1540, etc.) for that topic, and so on. In the example of topics, which correspond to different data sensitivity or security levels, part of the authentication process for a subscriber is to establish that their domain satisfies certain trust or security requirements as set forth in the policies that are to be applied by the M-CDS to the buffer channel. For instance, subscriber broker 1570 may be implemented in a trusted domain, while subscriber broker 1575 is implemented in a less trusted domain. Accordingly, for a topic corresponding to higher sensitivity data from the publisher 1520, the subscriber broker(s) (e.g., 1570) implemented in trusted domains may be permitted to couple to the M-CDS buffer channel corresponding to this topic, while lower domain subscriber brokers (e.g., 1575) may be permitted to participate on the M-CDS buffer channel corresponding to the low sensitivity topic, among a variety of other examples. Indeed, an M-CDS device may be utilized to implement topic-specific buffer channels (and data diodes) to correspond to a variety of different topics and implement a publisher-subscriber distribution system in a multi-domain environment.

A publish-subscribe implementation using CDS may offer a more dynamic solution than other more traditional approaches. For instance, publish-subscribe may not only decouple the systems and entities behind the publishers and subscribers, but also enable flexible data access, where subscribers can receive relevant data from diverse sources without pre-defined connections. Additionally, such a CDS implementation may be particularly adaptable to changing needs and architectures, enabling new domains and data sources to be easily integrated by their subscribing to relevant topics. Additionally, fine-grained (e.g., topic-based) authorizations may be managed by granting access to specific topics or data types based on user roles and permissions, as well as attribute-based access control, where granting access is based on specific attributes of the data or subscriber, offering more granular control. In some implementation, encryption and data anonymization may be supported to protect sensitive data in transit and at rest. Further, a CDS system employing publish-subscribe may reduce communication overhead compared to point-to-point connections and implement topic-based routing enabling efficient data distribution without flooding all subscribers with irrelevant data. Such solutions may also be comparatively easy to scale, for instance, allowing cloud-based solutions (employed CDS) to dynamically scale to meet changing demands, among other example advantages.

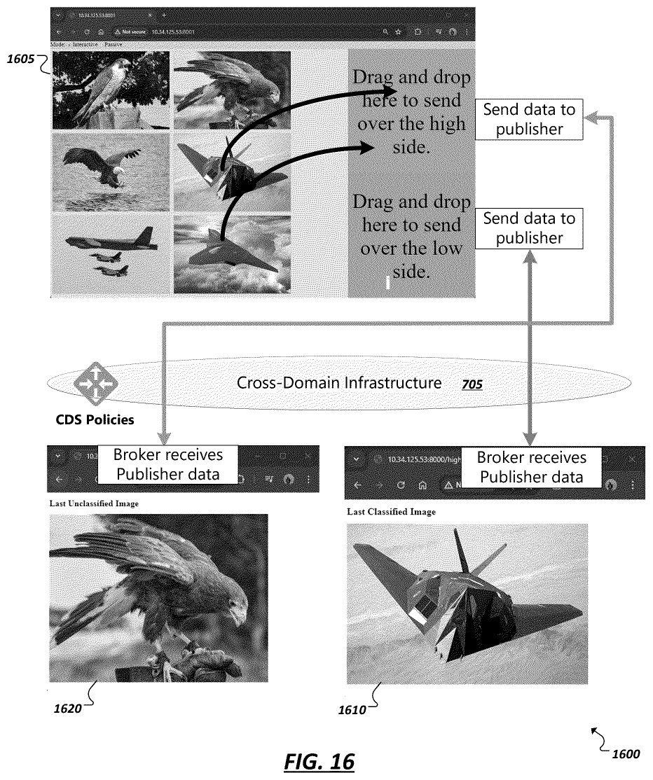

As one illustrative example, various sensor platforms may couple to an M-CDS device implementing a portion of a publish-subscribe system for sensor data. Turning to the diagram 1600 in FIG. 16, the sensor platforms may be photo or video sensors to generate image data 1605. The sensor platform may allow various images to be classified and tagged (e.g., manually or using Al) as including sensitive data or low sensitivity information. As an example, the sensor platform may be a camera-equipped user device registered as a government device (e.g., having access to private government networks, detected within a geofence corresponding to a classified or sensitive facility (e.g., a military base or defense contractor facility, etc.). The sensor platform may send data to secure or insecure partner domains. In one example, the user device may couple to an M-CDS device 705 (e.g., via a wireless communication channel) and may request the M-CDS manager to establish memory-based communication channels (through corresponding buffers) to couple to these domains via the M-CDS device. The sensor platform may request the CDS management to gain access to a destination-subscriber domain platform via a corresponding buffer channel. If access is granted, CDS management provides the information that can be used by the “publisher” to access the subscriber. CDS management can also notify the broker at the specific subscriber domain about the publisher of sensor data, and broker in the subscriber domain may send an acknowledgement of receiving a specific type of sensor data. With the publisher-source and subscriber-destination identified and authenticate, the CDS management may set up the data plane (e.g., and corresponding buffer) for the sensor data to reach the respective subscriber domain. The CDS management can then inform both the publisher in the sensor platform and the broker in the subscriber domain platform about the data plane and assign policies and credits for such communications. The sensor platform may then use the CDS to communicate with the subscribed domain platform (e.g., via a corresponding buffer). In the example of FIG. 16, separate CDS channels may be established for sending sensitive data (e.g., 1610) to a subscriber broker platform in a trusted domain and a separate CDS channel established for sending data (e.g., 1620) classified as less sensitive to a different subscriber broker in a different, less trusted domain. The established communication channel and corresponding data session may eventually be terminated based on the CDS management policies (e.g., credit run out, policy breach, etc.) to allow the CDS resources (e.g., shared memory) to be reused to implement another communication, among other examples.

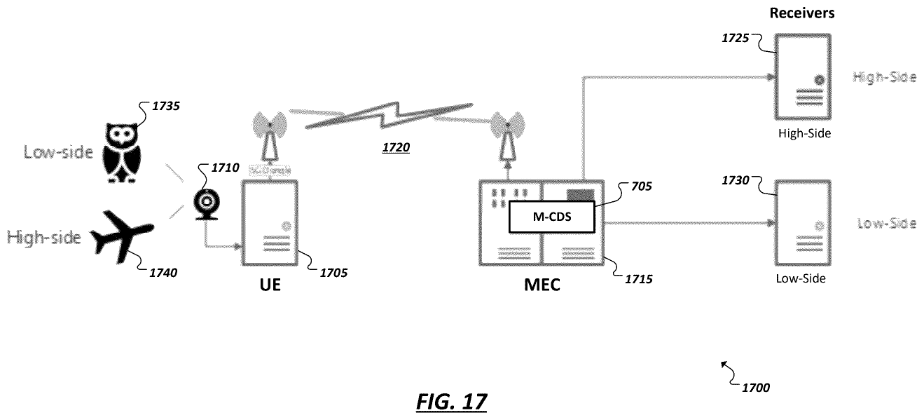

Turning to the simplified block diagram 1700 of FIG. 17, an example CDS publish-subscribe architecture is shown, where a user endpoint (UE) 1705 implements a publisher (e.g., using a camera module 1710 or other sensor on the US 1705) and connects to an M-CDS unit 705 (provided within a multi-access edge computing (MEC) unit 1715) over a wireless communication channel 1720. The MEC unit 1715 may be coupled to one or more other systems (e.g., 1725, 1730) corresponding to two different domains. The connection to the systems 1725, 1730 may be facilitated through the M-CDS unit 705. In one example, the UE 1705 may be implemented as a personal computing device with wireless connectivity (e.g., 5G or NextGen wireless). The MEC unit 1715 may implement a radio access network (RAN) base station and may include additional computational and network connectivity options such as ethernet and WiFi, among other examples. Systems 1725, 1730 may serve as destination platforms within a publish-subscribe architecture, one of the systems 1725 serving as a destination for “high”-side data (e.g., including an amount of classified, high sensitivity, confidential, or private information) and another system 1730 serving as a destination for normal data traffic (e.g., not containing such sensitive information).

The UE 1705 may be used to capture various photographic images (using camera module 1710). The images may be stored in a local directory and these images may be tagged individually, in this example, as either “public” or “classified” (e.g., tagged in their file names making them easy to distinguish). The tags “public” and “classified” may correspond to topics in the publish-subscribe architecture. When the destination platforms 1725, 1730 are all online and communicating from end to end, a user app may be launched on the UE 1705, which will read and publish “public” data from the directory over the message bus using a “low” topical channel implemented through the M-CDS 705. A subscriber application on the destination system 1730 may receive low side public data (e.g., to display, process, or otherwise use the data within a corresponding domain. In one example, the subscriber application operates under conventional IP network protocols using topical message bus access (e.g., such that no changes to the 5G base station (e.g., gNB) implemented by the MEC 1715 would be required). In this example, both low (e.g., 1735) and high (e.g., 1740) data files may be published to the message bus channels implemented through the M-CDS 705. The UE application may act as a publisher and selectively use one of two topical channels labeled (e.g., corresponding to “high” and “low” sensitivity data) of the M-CDS unit 705. Accordingly, the files (e.g., 1735, 1740) may be correctly published to the high or low channel from the UE 1705 across wireless communication channel 1720 (e.g., a 5G channel) to the MEC. In one example, the M-CDS 705 may be integrated within the MEC 1715 to implement a modified central unit (CU) to topically extract the “high” channel files.

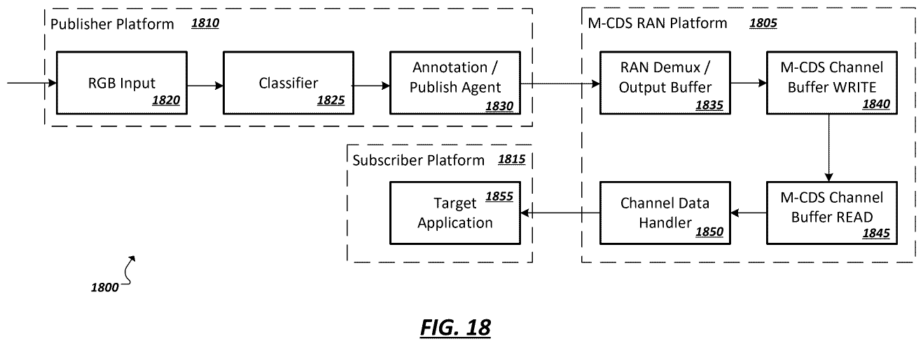

FIG. 18 is a flow diagram 1800 illustrating the example transaction flow for using a MEC or other RAN infrastructure element 1805 modified to include an M-CDS implementing buffer-based memory communication channels between a source or publishing system (e.g., 1810) and a destination-subscriber system 1815 (e.g., similar to the example system presented in FIG. 17). In this example a publisher system 1810 may receive or generate data 1820 (e.g., RGB image data) and may include a classifier to classify (at 1825) the data in one or more topics (e.g., a high-sensitivity topic and a low-sensitive topic, among a variety of different example topics). A publishing agent or other module may annotate (at 1830) the data to indicate (e.g., in a header, appended metadata, etc.) the topic(s) to apply to the data and the publisher platform 1810 may pass the data over a wireless communication channel to the M-CDS RAN platform 1805. A demultiplexing step may be performed at M-CDS RAN platform 1805 to correctly direct the data to be written 1840 to the buffer(s) implementing the topical channel(s) associated with the data. A subscriber platform 1815 may then perform a read of the buffer 1845 with the M-CDS RAN platform 1805 applying any specified policy enforcement to other data handling tasks (at 1850) specified for the buffer channel before the read is completed and sent to a target application 1855 on the subscriber platform. The target application 1855, in some implementations, may be a broker application and further distribute the data to one or more other subscribers. In some instances, the target application 1855 may consume the data (e.g., through further processing or analytics operations), store the data, display the data, among other example uses.

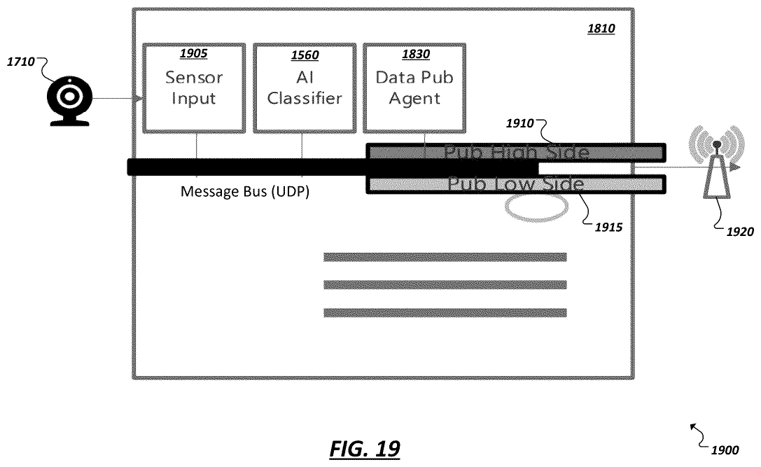

FIG. 19 is a simplified block diagram 1900 illustrating an example publisher platform 1810. In this example, the publisher platform can include a sensor input 1905 to receive image data from a camera sensor 1710 and an Al-based classifier 1560 which uses neural-network-based inferencing to detect classified objects present in images generated by the camera sensors. The data publisher agent 1830 appends a tag to data detected as including such classified information and publishes the data to either a classified 1910 or unclassified 1915 message bus channel. These message buses may correspond to requests to write data to corresponding topical M-CDS buffer channels. The write requests, in one example, may be transmitted wirelessly (over wireless communication channel 1920) to a M-CDS equipped MEC (e.g., via a 5G adapter on the publisher platform 1810).

A publish-subscribe message bus may be implemented, respectively, at publisher platforms and subscriber platforms. A given platform may act as either or both a subscriber or a publisher and may implement corresponding message buses. Separate message bus channels may be maintained for the various topics the platform either publishes to or is subscribed to. Each channel can carry data files published by authorized applications. In one example, separate M-CDS-based message bus channels may be implemented to bifurcate high-sensitivity data transfers from low-sensitivity data transfers between publishers and subscribers. For instance, a subscriber application may receive and display “low side public data”. This data may be published on a “low sensitivity” topic channel and reaches the subscriber app through the message bus implemented at least partially on the M-CDS device. A subscriber application can subscribe to specific channels to receive relevant data. When authorized to couple to the high channel buffer, the subscriber application can read data files from the M-CDS buffer associated with the high channel and access the files for further processing or distribution (e.g., within a trusted domain or network), among other examples.

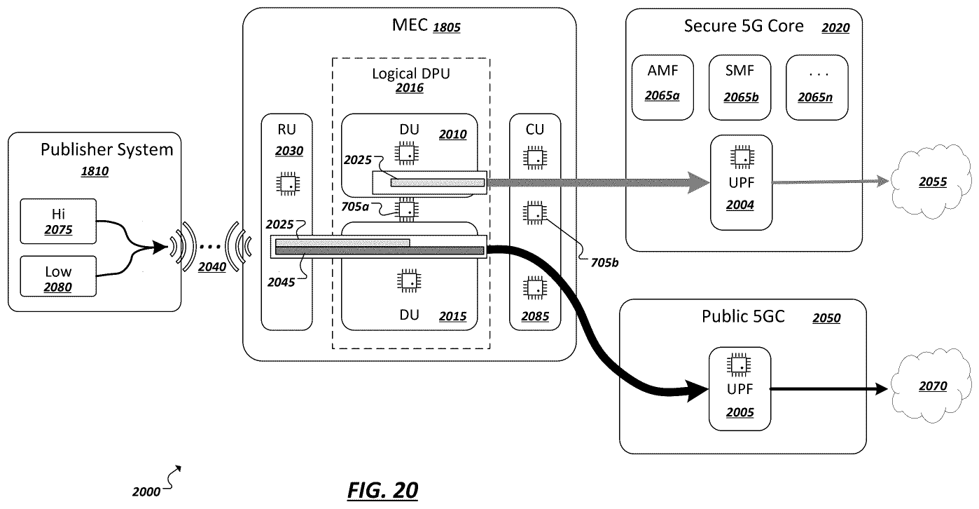

FIG. 20 is a simplified block diagram 2000 illustrating at least a portion of a MEC platform or another RAN platform equipped with an M-CDS device 705. In one example, the MEC platform can include a processor-based platform with radio head unit and 5G ORAN, gNodeB and core enabling a private 5G network. Demultiplexer logic may be used together with the shared memory buffer of the M-CDS to separation of data from the high-side data channel incoming from a publisher from data on the low-side data channel. In this example, an example MEC implementation 1805 is implemented that includes a logical distributed unit (DU) 2016 connected to the RU, the logical DU implemented through two separate devices 2010 and 2015, the first device 2010 implementing a DU associated with a higher trust domain than the other domain and the second device 2015 implementing a DU associated with this lower-trust domain. As such, two (or more) instances of the same component (e.g., the DU) or a chain of components (e.g., the DU and CU) representing a portion of a RAN processing pipeline, may be provided in a MEC base station 1805 to implement a split in the processing pipeline (e.g., a 5G processing pipeline) and create a separate and parallel pipeline path in the pipeline (e.g., to isolate a secured path to a secured or proprietary core network 2020 (e.g., a 5G core (5GC)). For instance, a CDS device 705a may be provided between the device 2010 or domain implementing a first DU and the device 2015 implementing the second DU that is to implement a secured alternative pipeline path 2025. Data (e.g., 2075, 2080) arriving at the radio unit (RU) (e.g., implemented by device 2030) over a wireless channel 2040 (e.g., 5G channel) from the publisher system 1810 may be parsed to determine whether to be forwarded onto the first device's DU (e.g., data 2075 containing high-sensitivity information) or the second device's DU (e.g., data 2080) using CDS device 705a (e.g., based on a topic tag attached to the data).

In some implementations, the use of a CDS device 705a and one or more redundant RAN components (e.g., implemented by devices 2010, 2015) to implement a processing pipeline split may facilitate a trusted and an untrusted network split within the MEC 1805. For instance, wireless core 2020 may be a trusted 5G core and couple to a proprietary, private, or other network (e.g., 2055) that corresponds to trusted subscribers in the publish-subscribe model. The network split facilitated through the CDS device 705a (and potentially other CDS devices (e.g., 705b)) can implement isolation between the network 2055 and the standard processing pipeline 2045, which feeds into an untrusted or public network 2070 (e.g., the internet), among other examples.

The core networks 2020, 2050 may include separate (and isolated relative to the other) user plane function (UPF) (e.g., 2004, 2005) to process the network data received on a respective one of the pipelines 2025, 2045). In some implementations, the trusted, private, or proprietary core network 2020 may provide additional components for further enhanced processing (e.g., for security or other specialized policy enforcement or application), in addition to other components such as an Access and Mobility Management Function (AMF) 2065a, a Session Management Function (SMF) 2065b, and other components (e.g., 2065n) in the 5G core (e.g., 2020).

Generally, the “softwarization” of RAN network functions may allow for highly flexible and configurable pipeline splitting options, where any number of RAN subfunctions (e.g., within MEC 1805) can be created and implemented as microservices and CDS devices may be utilized to implement isolation through pipeline splits. Indeed, a variety of different access points within a base station may make use of an M-CDS device (e.g., 705a, 705b) to transfer data between components of the base station or MEC, and thereby create isolation through an M-CDS shared memory buffer in the base station between the publisher and/or less trusted elements of the base station and the high-side subscriber infrastructure domain. In one example implementations, an M-CDS device (e.g., 705a) may be provided to implement separation occurring at a low-side DU 2015 with the M-CDS device 705a being used to transfer data to a high-side DU and CU 2010 to complete processing and transmission to a secured, high-side 5G network UPF (e.g., 2004). In this example, there is a logical DU/CU 2016 reflecting low and high side processing and state synchronization ensuring proper session and control plane coordination and management between low and high side DU and CU counterparts. The upside is earlier separation of the high-side stream at the DU which limits propagation of data in the less secure low-side portion of the base station (e.g., at the expense of increased operational complexity (e.g., management and synchronization of both high side DU and CU and low-side DU-CU stacks, simultaneously)). From a deployment perspective, opening channels for messaging between the low and high side modules at the DU involves an M-CDS device at each DU. Other implementations of an MEC or base station may deploy an M-CDS device to separate low from high traffic at other points in the base station. For instance, one alternative may intercept data in the CU reducing the dependency on high side synchronized sub-systems to just the CU/core. This approach may eliminate a bifurcated high-low DU component, reducing the potential attack surface and lowering the operational and deployment complexity of the total system, among other example considerations and implementations.

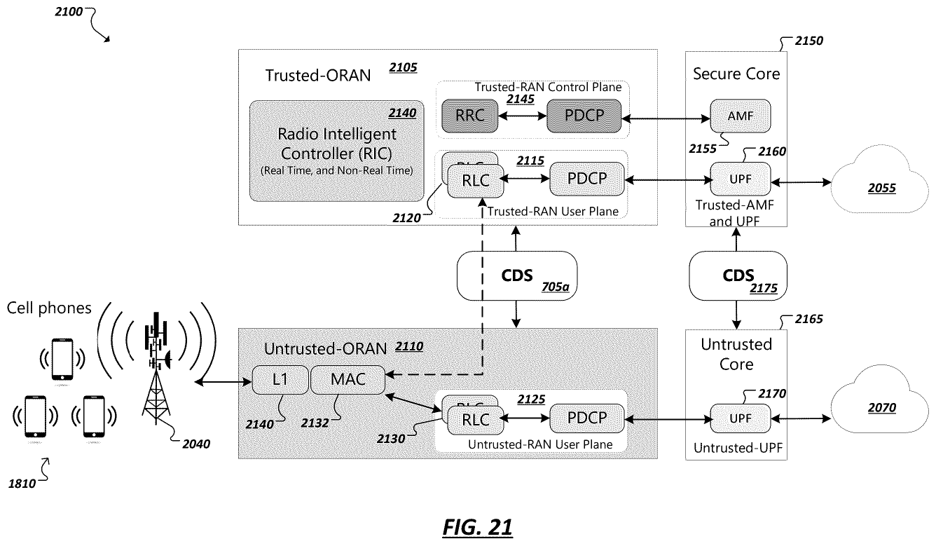

Turning to FIG. 21, a simplified block diagram 2100 is shown illustrating an example of the division of the user plane functions of an example ORAN based-RAN in an example MEC. In this example, the division is made at the RLC layer, dividing the RLC layer between a trusted domain 2105 and an untrusted domain 2110 to split the data processing between trusted and untrusted networks, with a CDS device 705a used to pass data between the domains 2105, 2110. A CU may implement multiple concurrent RLC sessions (e.g., 2120, 2130) and the MAC 2132 may determine which RLC session to handle given data arriving at a base station from user endpoints or other publisher systems (e.g., 1810) over a wireless connection (e.g., 2040). In this example, to divide the processing pipeline at the RLC layer, RLC sessions may be implemented both on the untrusted RAN domain 2110 (at 2130) and on the trusted RAN domain 2105 (at 2120). A CDS device 705a (e.g., an M-CDS device, etc.) may implement a connection between the MAC service 2132 and one of the trusted RLC functions 2120 (or the trusted RAN user plane 2115). Data sent through the CDS device 705a may be injected into the trusted alternative processing pipeline, enjoying the services of radio intelligent controller (RIC) 2140 and the trusted RAN control plane 2145 implemented in the trusted domain 2105, and being further passed to the trusted core network 2150 (and trusted AMF 2155 and UPF 2160). Accordingly, a secure network flow may be implemented in connection with a secured, sensitive, proprietary, private, or otherwise trusted network (e.g., 2055) may be facilitated through the trusted processing pipeline implemented using the CDS 705a. For other data (e.g., not identified as corresponding to a trusted processing pipeline), the MAC 2132 may instead send the data to an RLC session 2130 implemented on the lower-trust or standard RAN 2110 (e.g., using RAN user plane 2125) to cause the data to be handled by the lower trust or standard core network 2165 (and UPF 2170) before being injected onto the untrusted network 2070.

Publisher data can include hints or tags to cause a MEC to have a trusted RLC session 1820 handle the session (via CDS 1425), which will be used to trace the flow and cause the data to follow the trusted or secure processing pipeline branch. Indeed, such RAN or MEC implementations solutions may allow cross-domain functionality without necessitating any changes to existing ORAN protocols, any changes to end-to-end applications, or any changes to 3GPP or other operations. Further, during connection establishment, the publisher system (e.g., 1810) may establish a dedicated bearer and a unique RLC session, which would enable the ORAN stack to be separated at the RLC layer to process the flow in the trusted part of network as desired, among other example features. For instance, an RLC session identifier (ID) may be used to distinguish the ORAN between secure and unsecure, or trusted and untrusted infrastructure processing, among other example features.

It should be appreciated that the example of FIG. 21, focusing on RAN pipeline splitting at the RLC is but one example of the types of interfaces that may be hardened or split using an example CDS device. Indeed, a variety of different interfaces within a MEC or base station or other network appliance used in a publish-subscribe architecture may be enhanced through the use of an M-CDS device. Further, in the case of processing pipeline splitting, M-CDS devices may be used to split a single pipeline into more than two parallel pipelines (e.g., for more than two topical message channels, with different policies, functions, trust levels, etc.). Indeed, within ORAN implementations, a variety of split options may be facilitated using CDS devices, particularly where domains of differing trust levels or vendor are utilized. As one additional example, a CDS may be utilized to implement a pipeline split where the RLC radio bearers for trusted packet flows along with the RRC are located in the trusted domain, whereas the RLC radio bearers for untrusted packet flows are located in the untrusted domain. A variety of advantageous RAN split options may be identified and facilitated using CDS devices in order to improve performance and resource utilization in multi-dimensional environments and optimal operation of ORAN systems, among other example implementations.

As one example implementation, a publish-subscribe architecture may be implemented, which combines a RAN (e.g., 5G ORAN) base station and M-CDS device coupled to one or both of the publisher(s) and subscriber(s) by wireless (e.g., 5G) communication channels. The system may be utilized to enable confidential or classified information to the secured communicated from a low-security or-trust domain to a high-security or trust domain, with the M-CDS device acting as a gate between the two domains. For instance, input sensor data in the form of video and images of objects captured in real-time in an environment may be processed to separate classified data from unclassified data. The classified and unclassified data will flow through a message bus and publish-subscribe data transport channels from a UE node implementing the publisher, over a 5G wireless connection to an M-CDS MEC unit where the secured data stream will be separated from the unclassified data stream. As such, using the M-CDS acting as a one-way data diode, the classified information may be transferred securely from the MEC's unclassified domain to the classified domain. A receiving subscriber application will process the classified data and transport to a destination where it can be visualized for confirmation of the results, among other example uses. In such implementations, the M-CDS device may provide a hardware security and software architecture which can provide a physically provable guarantee to isolate high risk transactions and enable systems with multi-level data security assertions. The M-CDS enables a hardware air gap/firewall between compute domains and ensures only one-way communications, essentially creating a data diode preventing information from a trusted domain to flow to an untrusted one or visa-versa. In some implementations, the M-CDS device can couple to other components using communication channels supporting direct memory rights and ready (e.g., CXL). The publisher and/or subscriber applications may utilize software-implemented message buses corresponding to buffer channels implemented in the M-CDS shared memory. In one example, a modular software framework based on industry standard message bus communications and Open Container Initiative (OCI)-compliant container technology (e.g., Situational Awareness at the Dynamic Edge (SADE)), may be used to support resilient, autonomous edge applications operations. Separate subscriber channels for classified and unclassified, high-sensitivity and low sensitivity, and other classifications may be implemented. In one example, a multimodal sensor ingestion container manages and captures data streams at the published (e.g., from the target sensor, such as an RGB video camera). The publisher may additionally include an inferencing container (e.g., built on an OpenVINO™ pipeline) to host the Al classification functionality for the publisher trained to recognize classified versus unclassified data and appropriately tag that data for publishing to the message bus. The publisher then attaches the data streams to their appropriate channels which is propagated through a 5G pipeline to a MEC outfitted with M-CDS. On the MEC, a secured and credentialed subscriber to the message bus can extract published data from the appropriate channel and push this from low to high side domain using M-CDS. The MEC can implement a complete 5G stack including RAN, 3GPP, and core to enable functional MEC capability and allow the creation of a private 5G network for transport of the publisher data, among other example implementations.

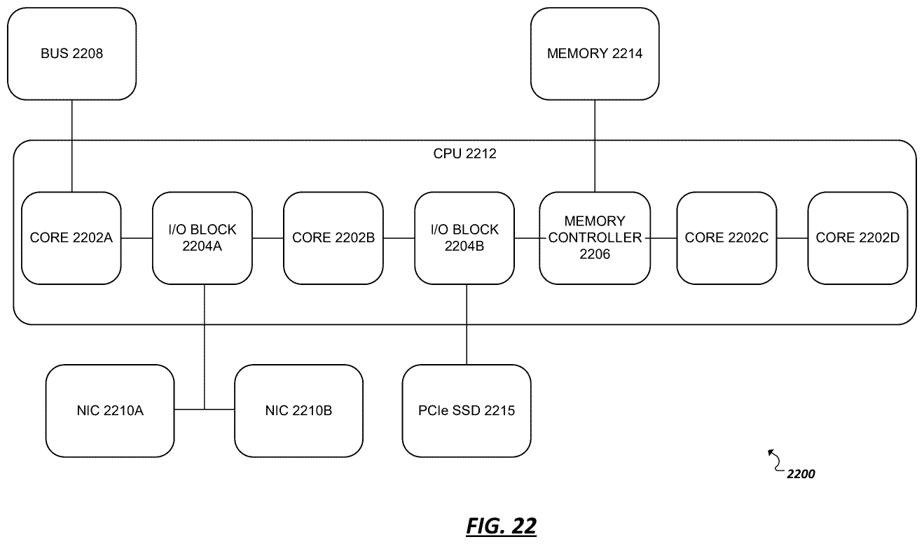

Note that the apparatus′, methods′, and systems described above may be implemented in any electronic device or system as aforementioned. As a specific illustration, FIG. 22 provides an exemplary implementation of a processing device such as one that may be included in a system or platform in a publish-subscribe architecture, such as discussed herein. It should be appreciated that other processor architectures may be provided to implement the functionality and processing of requests by an example network processing device, including the implementation of the example CDS device components and functionality discussed above.

Referring to FIG. 22, a block diagram 2200 is shown of an example data processor device (e.g., a central processing unit (CPU)) 2212 coupled to various other components of a platform in accordance with certain embodiments. Although CPU 2212 depicts a particular configuration, the cores and other components of CPU 2212 may be arranged in any suitable manner. CPU 2212 may comprise any processor or processing device, such as a microprocessor, an embedded processor, a digital signal processor (DSP), a network processor, an application processor, a co-processor, a system on a chip (SOC), or other device to execute code. CPU 2212, in the depicted embodiment, includes four processing elements (cores 2202 in the depicted embodiment), which may include asymmetric processing elements or symmetric processing elements. However, CPU 2212 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 2212, as illustrated in FIG. 22, includes four cores-cores 2202A, 2202B, 2202C, and 2202D, though a CPU may include any suitable number of cores. Here, cores 2202 may be considered symmetric cores. In another embodiment, cores may include one or more out-of-order processor cores or one or more in-order processor cores. However, cores 2202 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 2202 may include a decode module coupled to a fetch unit to decode fetched elements. Fetch logic, in one embodiment, includes individual sequencers associated with thread slots of cores 2202. Usually a core 2202 is associated with a first ISA, which defines/specifies instructions executable on core 2202. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, decoders may, in one embodiment, include logic designed or adapted to recognize specific instructions, such as transactional instructions. As a result of the recognition by the decoders, the architecture of core 2202 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 2202, in one embodiment, recognize the same ISA (or a subset thereof). Alternatively, in a heterogeneous core environment, a decoder of one or more cores (e.g., core 2202B) may recognize a second ISA (either a subset of the first ISA or a distinct ISA).

In various embodiments, cores 2202 may also include one or more arithmetic logic units (ALUs), floating point units (FPUs), caches, instruction pipelines, interrupt handling hardware, registers, or other suitable hardware to facilitate the operations of the cores 2202.

Bus 2208 may represent any suitable interconnect coupled to CPU 2212. In one example, bus 2208 may couple CPU 2212 to another CPU of platform logic (e.g., via UPI). I/O blocks 2204 represents interfacing logic to couple I/O devices 2210 and 2215 to cores of CPU 2212. In various embodiments, an I/O block 2204 may include an I/O controller that is integrated onto the same package as cores 2202 or may simply include interfacing logic to couple to an I/O controller that is located off-chip. As one example, I/O blocks 2204 may include PCIe interfacing logic. Similarly, memory controller 2206 represents interfacing logic to couple memory 2214 to cores of CPU 2212. In various embodiments, memory controller 2206 is integrated onto the same package as cores 2202. In alternative embodiments, a memory controller could be located off chip.

As various examples, in the embodiment depicted, core 2202A may have a relatively high bandwidth and lower latency to devices coupled to bus 2208 (e.g., other CPUs 2212) and to NICs 2210, but a relatively low bandwidth and higher latency to memory 2214 or core 2202D. Core 2202B may have relatively high bandwidths and low latency to both NICs 2210 and PCIe solid state drive (SSD) 2215 and moderate bandwidths and latencies to devices coupled to bus 2208 and core 2202D. Core 2202C would have relatively high bandwidths and low latencies to memory 2214 and core 2202D. Finally, core 2202D would have a relatively high bandwidth and low latency to core 2202C, but relatively low bandwidths and high latencies to NICs 2210, core 2202A, and devices coupled to bus 2208.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stages, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a processor; a memory, where the memory includes a shared memory region; a first interface to couple to a first device; a second interface to couple to a second device; a third interface to couple to a third device; and a cross-domain solutions (CDS) manager executable by the processor to: create a first buffer in the shared memory region to allow writes by the first device associated with a first software module and reads by the second device associated with a second software module; create a second buffer in the shared memory region separate from the first buffer to allow writes by the first device associated with the first software module and reads by the third device associated with a third software module; use the first buffer to implement a first memory-based communication link between the first software module and the second software module; and use the second buffer to implement a second memory-based communication link between the first software module and the third software module.

Example 2 includes the subject matter of example 1, where the first software module is executed in a first domain, the second software module is executed in a second domain, and the third software module is executed in a third domain.

Example 3 includes the subject matter of example 2, where the first domain is independent of the second domain.

Example 4 includes the subject matter of example 3, where the first domain is independent of the third domain, and the second domain is independent of the third domain.

Example 5 includes the subject matter of example 2, where a trust level of the second domain is higher than the third domain.

Example 6 includes the subject matter of any one of examples 1-5, where the first memory-based communication link is to communicate data of a first topic to a first subscriber in a publish-subscribe model, the first subscriber includes the second software module, and the second memory-based communication link is to communicate data of a second topic to a second subscriber in the publish-subscribe model, where the second subscriber includes the third software module.

Example 7 includes the subject matter of example 6, where first data from the first software module includes an indication that the first topic applies to the first data, and the CDS manager causes the first data to be written to the first buffer based on the indication.

Example 8 includes the subject matter of any one of examples 6-7, where the first topic corresponds to data of a first level of sensitivity and the second topic corresponds to data of a second, lower level of sensitivity.

Example 9 includes the subject matter of any one of examples 1-8, where at least one of the first interface, second interface, or third interface includes a wireless communication channel according to a wireless communication protocol.

Example 10 includes the subject matter of example 9, where the first memory-based communication link implements a first instance of a portion of a processing pipeline of the wireless communication protocol, and the second memory-based communication link implements a second parallel instance of the portion of the processing pipeline of the wireless communication protocol.

Example 11 includes the subject matter of example 10, where the first device implements at least a portion of a radio access network (RAN) radio unit (RU), and the second device implements at least a portion of a RAN distributed unit (DU).

Example 12 includes the subject matter of example 11, where the RAN DU includes a first RAN DU, the first instance of a portion of the processing pipeline includes the first RAN DU, and the second instance of the portion of the processing pipeline includes a second RAN DU.

Example 13 includes the subject matter of example 10, where the wireless communication protocol includes a 5G protocol.

Example 14 includes the subject matter of example 9, where each of the first interface, the second interface, and the third interface includes a respective wireless communication channel.

Example 15 includes the subject matter of any one of examples 1-14, where the first buffer is created based on a first buffer scheme to define a configuration of the first buffer, and the second buffer is created based on a second buffer scheme to define a configuration of the second buffer.

Example 16 includes the subject matter of example 15, where the first and second buffer schemes respectively define access rules for reads of the first and second buffers.

Example 17 includes the subject matter of example 15, where the first buffer scheme defines at least one of a protocol or a datagram format for communication of data over the first memory-based communication link, and the second buffer scheme defines at least one of a protocol or a datagram format for communication of data over the second memory-based communication link.

Example 18 includes the subject matter of any one of examples 1-17, where the CDS manager is further to collect statistics of use of the buffer by at least one of the first software module or the second software module, and the CDS manager controls access to the buffer by at least one of the second software module or the third software module based on the statistics.

Example 19 is a method including: creating a first buffer in a shared memory region of a memory-based cross-domain solutions (M-CDS) device to implement a first memory-based communication channel, where the first memory-based communication channel is between a first software module in a first domain and a second software module in a second domain; creating a second buffer in the shared memory region of the M-CDS device to implement a second memory-based communication channel between the first software module and a third software module in a third domain; receiving data on an interface of the M-CDS device; determining, from a classification of the data, that the data is to be written to the first buffer, where the data includes an identification of the classification; and using the M-CDS device to transfer the data to the second software module via the first buffer.

Example 20 includes the subject matter of example 19, where the first domain is independent of the second domain and the third domain, and the M-CDS device is independent of the first domain, the second domain, and the third domain.

Example 21 includes the subject matter of any one of examples 19-20, further including applying a first set of policies at the first buffer and a different set of policies at the second buffer, where access to the first buffer by the first software module and the second software module are based on the first set of policies.

Example 22 includes the subject matter of any one of examples 19-21, where the first memory-based communication channel corresponds to a first topic subscribed to by a first set of subscribers in a publish-subscribe model, the second memory-based communication channel corresponds to a different second topic subscribed to by a different second set of subscribers in the publish-subscribe model, the first set of subscribers includes the second software module, and the second set of subscribers includes the third software module.

Example 23 includes the subject matter of any one of examples 19-22, further including: determining conclusion of a communication between the first software module and the second software module; and retiring the first buffer based on the conclusion of the communication.

Example 24 includes the subject matter of any one of examples 19-23, where a trust level of the second domain is higher than the third domain.

Example 25 includes the subject matter of any one of examples 19-24, where the first memory-based communication link is to communicate data of a first topic to a first subscriber in a publish-subscribe model, the first subscriber includes the second software module, and the second memory-based communication link is to communicate data of a second topic to a second subscriber in the publish-subscribe model, where the second subscriber includes the third software module.

Example 26 includes the subject matter of example 25, where first data from the first software module includes an indication that the first topic applies to the first data, and the CDS manager causes the first data to be written to the first buffer based on the indication.

Example 27 includes the subject matter of example 25, where the first topic corresponds to data of a first level of sensitivity and the second topic corresponds to data of a second, lower level of sensitivity.

Example 28 includes the subject matter of any one of examples 19-27, where at least one of the first interface, second interface, or third interface includes a wireless communication channel according to a wireless communication protocol.

Example 29 includes the subject matter of example 28, where the first memory-based communication link implements a first instance of a portion of a processing pipeline of the wireless communication protocol, and the second memory-based communication link implements a second parallel instance of the portion of the processing pipeline of the wireless communication protocol.

Example 30 includes the subject matter of example 29, where the first device implements at least a portion of a radio access network (RAN) radio unit (RU), and the second device implements at least a portion of a RAN distributed unit (DU).

Example 31 includes the subject matter of example 30, where the RAN DU includes a first RAN DU, the first instance of a portion of the processing pipeline includes the first RAN DU, and the second instance of the portion of the processing pipeline includes a second RAN DU.

Example 32 includes the subject matter of any one of examples 29-31, where the wireless communication protocol includes a 5G protocol.

Example 33 includes the subject matter of any one of examples 28-32, where each of the first interface, the second interface, and the third interface includes a respective wireless communication channel.

Example 34 includes the subject matter of any one of examples 19-33, where the first buffer is created based on a first buffer scheme to define a configuration of the first buffer, and the second buffer is created based on a second buffer scheme to define a configuration of the second buffer.

Example 35 includes the subject matter of example 34, where the first and second buffer schemes respectively define access rules for reads of the first and second buffers.

Example 36 includes the subject matter of any one of examples 34-35, where the first buffer scheme defines at least one of a protocol or a datagram format for communication of data over the first memory-based communication link, and the second buffer scheme defines at least one of a protocol or a datagram format for communication of data over the second memory-based communication link.

Example 37 includes the subject matter of any one of examples 19-36, where the CDS manager is further to collect statistics of use of the buffer by at least one of the first software module or the second software module, and the CDS manager controls access to the buffer by at least one of the second software module or the third software module based on the statistics.

Example 38 is a system including means to perform the method of any one of examples 19-37.

Example 39 is a system including: a publisher system; and a memory-based cross-domain solutions (M-CDS) device including: a processor; a memory, where the memory includes a shared memory region; a first interface to couple to the publisher system; one or more second interfaces to couple to a set of subscriber systems; a cross-domain solutions (CDS) manager executable by the processor to: create a first buffer in the shared memory region to allow writes by the publisher system and reads by at least a first subscriber system in the set of subscriber systems; create a second buffer in the shared memory region separate from the first buffer to allow writes by the publisher system and reads by a second subscriber system in the set of subscriber systems; use the first buffer to implement a first memory-based communication link between the publisher system and the first subscriber system associated with a first topic; and use the second buffer to implement a second memory-based communication link between the publisher system and the second subscriber system associated with a second topic.

Example 40 includes the subject matter of example 39, where the publisher system is executed in a first domain, the second subscriber system is executed in a second domain, and the first domain is independent of the second domain.

Example 41 includes the subject matter of example 40, where the first domain and the second domain each include a respective one of an operating system or hypervisor.

Example 42 includes the subject matter of any one of examples 39-41, further including a wireless base station including the M-CDS device.

Example 43 includes the subject matter of any one of examples 39-42, where the publisher system includes a classification sub-system to: determine a topic in a plurality of topics to apply to a data; and tag the data to indicate the topic to the M-CDS device, where the M-CDS device causes the data to be written to either the first buffer or the second buffer based on the topic.

Example 44 includes the subject matter of any one of examples 39-43, where the M-CDS device includes the apparatus of any one of examples 1-18.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a processor;
a memory, wherein the memory comprises a shared memory region;
a first interface to couple to a first device;
a second interface to couple to a second device;
a third interface to couple to a third device; and
a cross-domain solutions (CDS) manager comprising instructions executable by the processor to:
create a first buffer in the shared memory region to allow writes by the first device associated with a first software module and reads by the second device associated with a second software module;
create a second buffer in the shared memory region separate from the first buffer to allow writes by the first device associated with the first software module and reads by the third device associated with a third software module;
use the first buffer to implement a first memory-based communication link between the first software module and the second software module; and
use the second buffer to implement a second memory-based communication link between the first software module and the third software module.

2. The apparatus of claim 1, wherein the first software module is executed in a first domain, the second software module is executed in a second domain, and the third software module is executed in a third domain.

3. The apparatus of claim 2, wherein the first domain is independent of the second domain.

4. The apparatus of claim 3, wherein the first domain is independent of the third domain, and the second domain is independent of the third domain.

5. The apparatus of claim 2, wherein a trust level of the second domain is higher than the third domain.

6. The apparatus of claim 1, wherein the first memory-based communication link is to communicate data of a first topic to a first subscriber in a publish-subscribe model, the first subscriber comprises the second software module, and the second memory-based communication link is to communicate data of a second topic to a second subscriber in the publish-subscribe model, wherein the second subscriber comprises the third software module.

7. The apparatus of claim 6, wherein first data from the first software module comprises an indication that the first topic applies to the first data, and the instructions are further executable to cause the first data to be written to the first buffer based on the indication.

8. The apparatus of claim 6, wherein the first topic corresponds to data of a first level of sensitivity and the second topic corresponds to data of a second, lower level of sensitivity.

9. The apparatus of claim 1, wherein at least one of the first interface, second interface, or third interface comprises a wireless communication channel according to a wireless communication protocol.

10. The apparatus of claim 9, wherein the first memory-based communication link implements a first instance of a portion of a processing pipeline of the wireless communication protocol, and the second memory-based communication link implements a second parallel instance of the portion of the processing pipeline of the wireless communication protocol.

11. The apparatus of claim 10, wherein the first device is to implement at least a portion of a radio access network (RAN) radio unit (RU), and the second device is to implement at least a portion of a RAN distributed unit (DU).

12. The apparatus of claim 11, wherein the RAN DU comprises a first RAN DU, the first instance of the portion of the processing pipeline comprises the first RAN DU, and the second instance of the portion of the processing pipeline comprises a second RAN DU.

13. The apparatus of claim 1, wherein the first buffer is created based on a first buffer scheme to define a configuration of the first buffer, and the second buffer is created based on a second buffer scheme to define a configuration of the second buffer.

14. The apparatus of claim 13, wherein the first and second buffer schemes respectively define access rules for reads of the first and second buffers.

15. A method comprising:
creating a first buffer in a shared memory region of a memory-based cross-domain solutions (M-CDS) device to implement a first memory-based communication channel, wherein the first memory-based communication channel is between a first software module in a first domain and a second software module in a second domain;
creating a second buffer in the shared memory region of the M-CDS device to implement a second memory-based communication channel between the first software module and a third software module in a third domain;
receiving data on an interface of the M-CDS device;
determining, from a classification of the data, that the data is to be written to the first buffer, wherein the data comprises an identification of the classification; and
using the M-CDS device to transfer the data to the second software module via the first buffer.

16. The method of claim 15, wherein the first memory-based communication channel corresponds to a first topic subscribed to by a first set of subscribers in a publish-subscribe model, the second memory-based communication channel corresponds to a different second topic subscribed to by a different second set of subscribers in the publish-subscribe model, the first set of subscribers comprises the second software module, and the second set of subscribers comprises the third software module.

17. The method of claim 15, further comprising:
determining conclusion of a communication between the first software module and the second software module; and
retiring the first buffer based on the conclusion of the communication.

18. A system comprising:
a publisher system; and
a memory-based cross-domain solutions (M-CDS) device comprising:
a processor;
a memory, wherein the memory comprises a shared memory region;
a first interface to couple to the publisher system;
one or more second interfaces to couple to a set of subscriber systems;
a cross-domain solutions (CDS) manager executable by the processor to:
create a first buffer in the shared memory region to allow writes by the publisher system and reads by at least a first subscriber system in the set of subscriber systems;
create a second buffer in the shared memory region separate from the first buffer to allow writes by the publisher system and reads by a second subscriber system in the set of subscriber systems;
use the first buffer to implement a first memory-based communication link between the publisher system and the first subscriber system associated with a first topic; and
use the second buffer to implement a second memory-based communication link between the publisher system and the second subscriber system associated with a second topic.

19. The system of claim 18, further comprising a wireless base station comprising the M-CDS device.

20. The system of claim 18, wherein the publisher system comprises a classification sub-system to:
determine a topic in a plurality of topics to apply to data; and
tag the data to indicate the topic to the M-CDS device, wherein the M-CDS device causes the data to be written to either the first buffer or the second buffer based on the topic.
